(19) United States
(12) Patent Application Publication
(10) Pub. No.: US 2025/0330041 A1
(43) Pub. Date: Oct. 23, 2025

(54) ENABLING RADIO BASE STATIONS FOR ANCILLARY SERVICES

(71) Applicant: Telefonaktiebolaget LM Ericsson (publ), Stockholm (SE)

(72) Inventors: Lackis ELEFTHERIADIS, Valbo (SE); Brigitte JAUMARD, Montreal (CA); Bassant SELIM, Laval (CA); Oleg GORBATOV, Luleå (SE); Leonardo DIAS, Montreal (CA)

(21) Appl. No.: 18/868,563

(22) PCT Filed: Nov. 29, 2022
(86) PCT No.: PCT/IB2022/061553

§ 371 Date: Nov. 22, 2024

Related U.S. Application Data
(60) Provisional application No. 63/346,671, filed on May 27, 2022.

(51) Int. Cl. H02J 13/00

(52) U.S. Cl. CPC H02J 13/00022; H02J 13/00002

(57) ABSTRACT

A method, system and apparatus are disclosed. A management node configured to communicate with a power grid operator and with a plurality of RBSs is provided. Each of the plurality of RBSs is configured to be switchable between power from a power grid and power from a respective plurality of backup battery units associated with the RBS. The management node is configured to: determine a primary subset of the plurality of RBSs to participate in at least one FCR event occurring over a predefined time interval, and determine a standby subset of the plurality of RBSs that are each configured to participate in the at least one FCR event in place of a failure of a respective one of the primary subset of the plurality of RBSs.

### TECHNICAL FIELD

The present disclosure relates to wireless communications, and in particular, to enabling provision of ancillary services (e.g., Frequency Containment Reserve (FCR) events/services) by radio base stations in a wireless communication network.

### BACKGROUND

Fifth Generation New Radio (5G NR) services and high performance 5G-enabled radio units open several opportunities for enterprises, such as utilities and Mobile Network Operators (MNO), enabling various business-to-business (B2B) operations. One aspect of future business is the sustainability approach of the companies related to their operations, e.g., aimed at reducing negative environmental impacts, negative social impacts, etc., of these operations. Sustainability may be enabled/improved by the use of new communication technologies, requirements, and capabilities, such as 5G NR.

Utility operators, including transmission system operators (TSO) and distribution system operators (DSO), face a challenge in enhancing their sustainability while maintaining efficient operation for the power grids they operate. Further, an electricity grid's infrastructure (e.g., construction of power lines and power substations) often has a much longer cycle and investment when compared to other business verticals (such as telecommunications businesses).

In addition, although the installed capacity of renewable energy in the power grid tends to increase over time, user demand and energy consumption also increases at the same time. Since renewable energy cannot be predicted, the power grid may at times be volatile in terms of the balance between the power generation and demand (consumption), for example, due to the stochastic characteristic of these power sources. Planning/operating the power grid in an efficient and stable way for delivering energy to users/customers with high availability/reliability, while at the same time improving sustainability, is an arduous task for utility operators.

To help mitigate this problem, it has been proposed that utilities encourage and invest in Ancillary Services (AS). Ancillary services are trades of energy performed by selected electricity customers (e.g., participating enterprise customers) which are affected by increasing or decreasing the participating customers' energy consumption when answering grid requests, where special (e.g., monetary) incentives may be provided for those customers who participate. These ancillary services support the power grid to help maintain the proper balance between generation and consumption and thus improve grid stability.

One service in ancillary services is the Frequency Containment Reserve (FCR) service. In FCR service, the active operating reserves (e.g., of the participating customers) are used to stabilize the power grid frequency deviations (fluctuations) from its nominal value (e.g., 50 Hz or 60 Hz).

The FCR service is divided into two different services, named: Frequency Containment Reserve for Normal Operation (FCR-N) and Frequency Containment Reserve for Disturbances (FCR-D). These reserves, also known as FCR capacities, may be auctioned by the utility and participating customers (e.g., the auction may occur a day-ahead (which may differ per country) of when the FCR capacities are needed) based on an hourly (or other time-period) market basis, and with a predefined minimum power bid.

In addition, to participate in the bidding process, some general requirements may need to be fulfilled by a participating customer, such as prequalification of the customer's equipment, to obtain approval from the utility company prior to participating. These requirements may vary by market/location/region/etc. Below is Table 1 that is example requirements for participating in an electricity market, in this case, Sweden's electricity market:

TABLE 1
FCR-N and FCR-D Characteristics for the Swedish market.

| | FCR-N | | FCR-D | |
|---|---|---|---|---|
| Minimum bid | 0.1 | MW | 0.1 | MW |
| size | | | | |
| Activation | Automatically at frequency | | Automatically at a | |
| | deviations in the range | | frequency deviation below | |
| | 49.90-50.10 Hz | | 49.90-49.50 Hz (FCR-D | |
| | | | upwards) and above | |
| | | | 50.1-50-5 Hz (FCR-D | |
| | | | downwards) | |
| Activation time | 63% within 60 seconds and | | 50% within 5 seconds and | |
| | 100% within 3 minutes | | up to 100% within 30 | |
| | | | seconds | |
| Minimum | 0.1 MW for Sweden | | 0.1 MW for Sweden | |
| Volume | | | | |
| Requirement | | | | |
| Availability | 20 | min | 20 | min |
| (minimum) | | | | |

| General | Approved prequalification | |
|---|---|---|
| Requirements | Real-time measurement | |
| | Electronic communication | |
| | Endurance | |
| Miscellaneous | Symmetric product | Unsymmetric product |

As described in Table 1, FCR-N service requires that activation time be 63% within 60 seconds and 100% within 3 minutes, i.e., within 60 seconds, the participating entity/customer must reduce (or increase, depending on the configuration/signaling) its power consumption by 63% within 60 seconds, and by 100% within 3 minutes.

Existing systems consider enabling the FCR energy service for utilities with the related components and functions (such a frequency monitoring), and such systems utilize various strategies for ancillary services when using battery energy storage systems. For example, in some power systems, technical requirements for FCR do not allow controlling the battery storage systems in other ways than on the basis of frequency. Thus, control mechanisms have been proposed such as recovering state of charge (SoC) that are in line with such regulations and maximize battery storage system profit using the lifeline model of the battery storage system.

Existing systems have considered optimal bidding strategy for battery storage in power markets. Battery storage could increase its profitability by providing fast regulation service under a performance-based regulation mechanism, which better exploits a battery's fast ramping capability. However, battery life might be decreased by frequent charge-discharge cycling, especially when providing fast regulation service. It is profitable for battery storage to extend its service life by limiting its operational strategy to some degree. Thus, the incorporating a battery cycle life model into a profit maximization model to determine the optimal bids in day-ahead energy, spinning reserve, and regulation markets, may improve profitability of such operations.

Existing systems consider determining a suitable strategy that allows a battery energy storage system owner to maximize the profit when participating in an electricity market. For example, a Mixed Integer Linear Programming (MILP) optimization problem has been proposed for determining a battery energy storage system's optimal operation. The formulation includes a battery degradation model based on an upper piecewise linear approximation method. However, existing systems may be too expensive to implement, which reduces profitability.

Thus, existing systems for battery energy storage may not be optimally suited for providing ancillary services to utilities.

### SUMMARY

In embodiments of the present disclosure, multiple entities of radio base stations/network nodes (including local batteries) in one or more clusters may be coordinated for ancillary services/FCR, wherein the batteries are also used as radio base station/network node backup batteries, and not only for AS (e.g., FCR) service, and wherein the variation of radio traffic load (and therefore power consumption at the radio base station (RBS)) may be dynamic.

Embodiments of the present disclosure consider generating different profiles to control multiple batteries, on multiple radio base stations (RBSs), clustering the RBSs efficiently, e.g., based on power levels, battery degradation (e.g., battery life cycle), cost performance, physical proximity, etc., selecting the best RBS to participate, and selecting one or more standby RBS as backups.

Embodiments of the present disclosure utilize a control strategy to cluster RBS efficiently in response to FCR requests. A coordination algorithm to control a radio access network (RAN) when participating in the FCR service is disclosed. In some embodiments, the objective for the MNO/CSP may be to maximize profit while meeting the FCR minimum requirements and maintaining the Quality of Service (QoS) of the mobile network. In addition, to increase the system accuracy, reliability, and profitability, battery degradation and related costs are considered.

In some embodiments of the present disclosure, an optimization algorithm, such as, for example, a Dantzig-Wolfe decomposition method for Mixed Integer Linear Programming (MILP), may be utilized. For example, for each bid period (e.g., bidding hour), the most efficient group(s)/cluster(s) of RBSs are selected, e.g., forming a main cluster and a backup cluster (for redundant capacity). In some embodiments, the most efficient group(s)/cluster(s) may be determined by comparing one or more characteristics associated with each group/cluster.

In some embodiments of the present disclosure, after one or more clusters is selected, synchronization signals with various profiles (e.g., operation settings) are sent to each cluster in the system (e.g., to one or more RBSs in each cluster), to activate on. The various operations, based on the profiles, may improve coordination and efficiency upon activation of the power infrastructure apparatus, e.g., the power supply unit (PSU).

In some embodiments of the present disclosure, the transmission of the synchronization signal, including the AS profile, to the RBSs of each cluster occurs prior to the active hour, the AS profile optionally including a profile control, the profile control indicating at least one of: synchronization of the RBS in response to every demand from the network management unit to execute the AS profile, and local execution on at least one local controller for executing at least one power modification process based on at least one threshold indicated by the AS profile.

According to one aspect of the present disclosure, a management node configured to communicate with a power grid operator and with a plurality of RBSs is provided. Each of the plurality of RBSs is configured to be switchable between power from a power grid and power from a respective plurality of backup battery units associated with the RBS. The management node is configured to: determine a primary subset of the plurality of RBSs to participate in at least one Frequency Containment Reserve, FCR, event occurring over a predefined time interval, determine a standby subset of the plurality of RBSs that are each configured to participate in the at least one FCR event in place of a failure of a respective one of the primary subset of the plurality of RBSs, cause transmission of synchronization signals with operational settings to the primary and standby subsets of the plurality of RBSs where the operational settings being associated with participating in the at least one FCR event, and during an activation period, cause transmission of an activation signal to at least one of the primary subset of the plurality of RBSs, the activation signal being configured to cause a RBS to modify its power consumption based on the synchronization signal to participate in the at least one FCR event.

According to one aspect of the present disclosure, a RBS in communication with a management node is provided. The RBS is configured to be switchable between power from a power grid and power from a plurality of backup battery units associated with the RBS. The radio stations includes processing circuitry configured to: receive a synchronization signal with operational settings associated with primary and standby subsets of a plurality of RBSs forming a cluster where the operational settings is associated with participating in at least one Frequency Containment Reserve, FCR, event, during an activation period, receive an activation signal that is configured to cause the RBS to modify its power consumption based on the synchronization signal in response to the activation signal, and modify the power consumption of the RBS based on the synchronization signal and the activation signal to participate in the at least one FCR event.

According to another aspect of the present disclosure, a method implemented by a management node that is configured to communicate with a power grid operator and with a plurality of RBSs is provided. Each of the plurality of RBSs is configured to be switchable between power from a power grid and power from a respective plurality of backup battery units associated with the RBS. A primary subset of the plurality of RBSs to participate in at least one Frequency Containment Reserve, FCR, event occurring over a predefined time interval is determined. A standby subset of the plurality of RBSs that are each configured to participate in the at least one FCR event in place of a failure of a respective one of the primary subset of the plurality of RBSs is determined. Transmission is caused of synchronization signals with operational settings to the primary and standby subsets of the plurality of RBSs where the operational settings are associated with participating in the at least one FCR event. During an activation period, transmission is caused of an activation signal to at least one of the primary subset of the plurality of RBSs where the activation signal is configured to cause a RBS to modify its power consumption based on the synchronization signal to participate in the at least one FCR event.

According to another aspect of the present disclosure, a method implemented by a RBS that is in communication with a management node is provided. The RBS is configured to be switchable between power from a power grid and power from a plurality of backup battery units associated with the RBS. A synchronization signal is received with operational settings associated with primary and standby subsets of a plurality of RBSs forming a cluster where the operational settings are associated with participating in at least one Frequency Containment Reserve, FCR, event. During an activation period, an activation signal is received that is configured to cause the RBS to modify its power consumption based on the synchronization signal in response to the activation signal. The power consumption of the RBS is modified based on the synchronization signal and the activation signal to participate in the at least one FCR event.

Some embodiments therefore advantageously provide methods, systems, and apparatuses for enabling frequency containment functionality in a telecommunications network.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture according to the principles of the present disclosure;

FIG. 2 is a schematic diagram of an example network architecture illustrating a communication system connected via an intermediate network to a management node according to the principles in the present disclosure;

FIG. 3 is a flowchart illustrating example methods implemented in a communication system including a management node, an RBS/network node, and a wireless device for transmitting user data from a management node according to some embodiments of the present disclosure;

FIG. 4 is a flowchart illustrating example methods implemented in a communication system including a management node, an RBS/network node, and a wireless device for receiving user data at a management node according to some embodiments of the present disclosure;

FIG. 5 is a flowchart illustrating example methods implemented in a communication system including a management node, an RBS/network node and a wireless device for receiving user data at a management node according to some embodiments of the present disclosure;

FIG. 6 is a flowchart illustrating example methods implemented in a communication system including a management node, an RBS/network node and a wireless device for receiving user data at a management node according to some embodiments of the present disclosure;

FIG. 7 is a flowchart of an example process in an RBS for providing ancillary services based on control signals received from a management node according to some embodiments of the present disclosure;

FIG. 8 is a flowchart of another example process in an RBS according to some embodiments of the present disclosure;

FIG. 9 is a flowchart of an example process in a management node for managing the provision of ancillary services by a plurality of RBSs according to some embodiments of the present disclosure;

FIG. 10 is a flowchart of another example process in a management node according to some embodiments of the present disclosure;

FIG. 11 is a schematic diagram of an RBS in Normal Operation, FCR-UP Regulation Operation, and FCR-Down Regulation Operation, according to embodiments of the present disclosure;

FIG. 12 is a schematic diagram of an example network architecture according to some embodiments of the present disclosure;

FIG. 13 is a flowchart of an example optimization model workflow according to some embodiments of the present disclosure;

FIG. 14 is a schematic diagram of an example network including a primary cluster and a standby cluster according to some embodiments of the present disclosure;

FIG. 15 is a flowchart of an example solution according to some embodiments of the present disclosure;

FIG. 16 is a table of example configurations generated in an optimization model for bidding according to some embodiments of the present disclosure;

FIGS. 17A, 17B, 17C, and 17D are sequence diagrams of an example operation according to some embodiments of the present disclosure;

FIG. 18 is a schematic diagram of an example network architecture according to some embodiments of the present disclosure; and

FIG. 19 is a chart depicting example latency measurements in an RBS according to some embodiments of the present disclosure.

### DETAILED DESCRIPTION

As described above, existing systems for battery energy storage may not be suitable for providing ancillary services to utilities. For example, a participating customer, such as a communications service provider (CSP) and/or mobile network operator (MNO), may be a potential candidate for providing AS/FCR services. Current network deployments, such as 4G, 5G, etc., may allow CSPs to utilize network assets, such as radio base stations, network nodes, etc. which include local energy storage (e.g., batteries), and an operating network manager system, for enabling provision of various ancillary services to the power grid. Given the fast response capacity of batteries, such a source of power may be suitable for providing FCR. By participating, a CSP may extend its business to new industries and reduce its energy operational cost by providing ancillary services.

Many MNOs and utility companies have challenges and need new technologies and methods to enable a sustainable operation of their assets. Ancillary services enhance the sustainability of the utility companies while at the same time enable new revenues for MNOs by utilizing existing equipment/batteries, without requiring costly investment in a separate battery energy storage system.

Implementing ancillary services, such as FCR services, present several challenges for the telecom operators in efficiently orchestrating multiple sites to participate in the ancillary services.

A radio base station's (RBS) battery energy storage units have energy constraints and therefore can fail to provide FCR if the State-of-Charge (SoC) limits are reached, and hence may fail to participate during regulation requests (i.e., when FCR service is activated). Furthermore, and in a first constraint, the energy storage units may have to recover to a proper level in order to be able to attend future requests (ensuring the agreed FCR capacity), while not complying with the grid requests may lead to monetary penalties.

Prior to the bidding procedure (e.g., an FCR auction), to participate in the FCR service, and in a second constraint, a group of RBSs/network nodes may need to be identified and selected, fulfilling all FCR service requirements (such as the example requirements of Table 1), and at the same time maximizing the MNO's profit. In addition, during the bidding period (e.g., bidding hour), and during AS/FCR service, operation of the activated RBS must be sustained to operate with minimal or zero mobile service loss/interruption experienced by users of the MNO.

Moreover, and in a third constraint, some RBSs that are selected to participate in the bidding may generate alarms/faults/etc. and may suddenly be disconnected due to various reasons. Therefore, some backup approach may be necessary to increase the reliability of the system.

An additional challenge for CSPs is battery degradation, a fourth constraint, related to the amortization of the capital costs associated with the batteries. This natural process reduces the amount of energy that a battery can store over time. This process is inevitable but can be slowed down, e.g., with intelligent battery usage techniques, and control of the clusters.

One or more embodiments of the present invention help solve one or more problems/challenges with existing system.

Before describing in detail example embodiments, it is noted that the embodiments reside primarily in combinations of apparatus components and processing steps related to providing ancillary services (e.g., FCR event participation) to a power grid. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “radio base station” (RBS) used herein can be any kind of radio base station and/or network node comprised in a radio network which may further comprise any of base station (BS), base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The RBS may also comprise test equipment. The term “radio node” used herein may also be used to also denote a wireless device (WD) such as a wireless device (WD) or a radio network node/RBS.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device, (cloud-based) management node, or an RBS may be distributed over a plurality of wireless devices, RBSs, and/or management nodes. In other words, it is contemplated that the functions of the RBS, management node, and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide a system and functionality for efficiently managing a radio access network including multiple RBSs connected to the power grid and capable of participating in ancillary services, including FCR services.

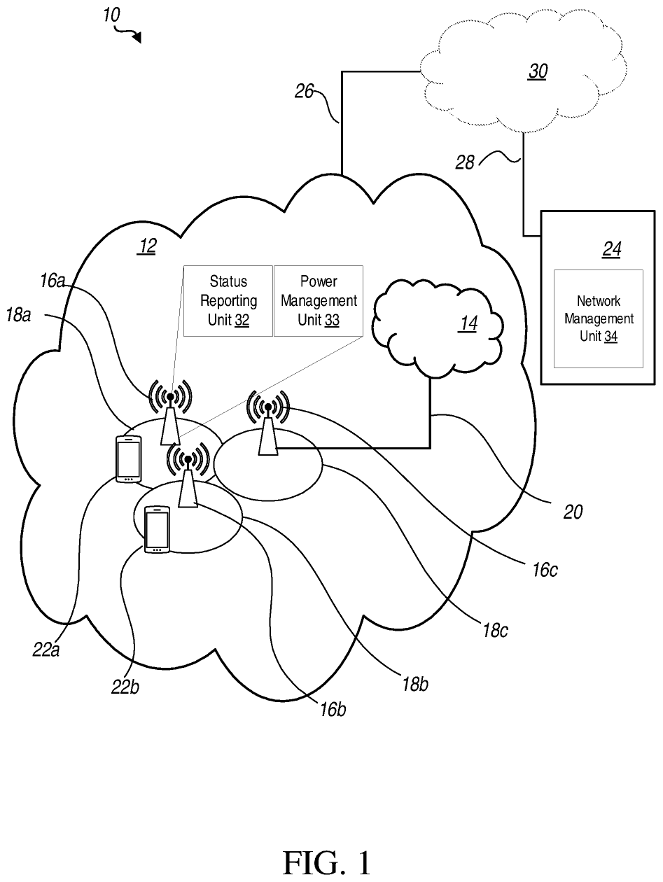

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core node 14. The access network 12 comprises a plurality of radio base stations (RBS) 16a, 16b, 16c (referred to collectively as radio base stations (RBSs) 16), such as network nodes, NBs, eNBs, gNBs, and/or other types of wireless access points/base stations, each defining a corresponding coverage area 18a, 18b, 18c (referred to collectively as coverage areas 18). Each RBS 16a, 16b, 16c is connectable to the core node 14 over a wired or wireless connection 20. A first wireless device (WD) 22a located in coverage area 18a is configured to wirelessly connect to, or be paged by, the corresponding RBS 16a. A second WD 22b in coverage area 18b is wirelessly connectable to the corresponding RBS 16b. While a plurality of WDs 22a, 22b (collectively referred to as wireless devices 22) are illustrated in this example, the disclosed embodiments are equally applicable to a situation where a sole WD 22 is in the coverage area or where a sole WD 22 is connecting to the corresponding RBS 16. Note that although only two WDs 22 and three RBSs 16 are shown for convenience, the communication system may include many more WDs 22 and RBSs 16.

Also, it is contemplated that a WD 22 can be in simultaneous communication and/or configured to separately communicate with more than one RBS 16 and more than one type of RBS 16. For example, a WD 22 can have dual connectivity with an RBS 16 that supports LTE and the same or a different RBS 16 that supports NR. As an example, WD 22 can be in communication with an eNB for LTE/E-UTRAN and a gNB for NR/NG-RAN.

The communication system 10 may itself be connected to a management node 24, which may be embodied in the hardware and/or software of a standalone server, a cloud-implemented server, a distributed server or as processing resources in a server farm. The management node 24 may be under the ownership or control of a service provider, or may be operated by the service provider or on behalf of the service provider. The connections 26, 28 between the communication system 10 and the management node 24 may extend directly from the core node 14 to the management node 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the RBSs 16 and/or the WDs 22 and the management node 24. The connectivity may be described as an over-the-top (OTT) connection. The management node 24 and the connected RBSs 16/WDs 22 are configured to communicate data and/or signaling (e.g., control signaling) via the OTT connection, using the access network 12, the core node 14, any intermediate network 30 (note from the network 30 in some cases the utility signal is provided from DSO/TSO) and possible further infrastructure (not shown) as intermediaries. The OTT connection may be transparent in the sense that at least some of the participating communication devices through which the OTT connection passes are unaware of routing of uplink and downlink communications. For example, an RBS 16 may not or need not be informed about the past routing of an incoming downlink communication with data originating from a management node 24 to be forwarded (e.g., handed over) to a connected WD 22a. Similarly, the RBS 16 need not be aware of the future routing of an outgoing uplink communication originating from the WD 22a towards the management node 24.

An RBS 16 may be configured to include a status reporting unit 32 which is configured to monitor and/or report one or more conditions/states/requirements etc. associated with the RBS 16, e.g., based on control signals received from the management node 24. An RBS 16 may be configured to include a power management unit 33 which is configured to control power supplied to and/or from one or more hardware components of RBS 16, e.g., based on control signals received from the management node 24.

A management node 24 is configured to include a network management unit 34 (e.g., an orchestrator and/or Operating and Support System (OSS)), which may be referred to as operating “in the cloud”. For example, the network management unit 34 may include an Ericsson Network Manager (ENM) or similar entity/function. Alternatively, in some embodiments of the present disclosure, the network management unit 34 may be located in core node 14, and/or in one or more RBS 16s such that at least some functionality associated with management node 24 may be performed in the core network 30 or access network 12 by one or more nodes/devices described herein.

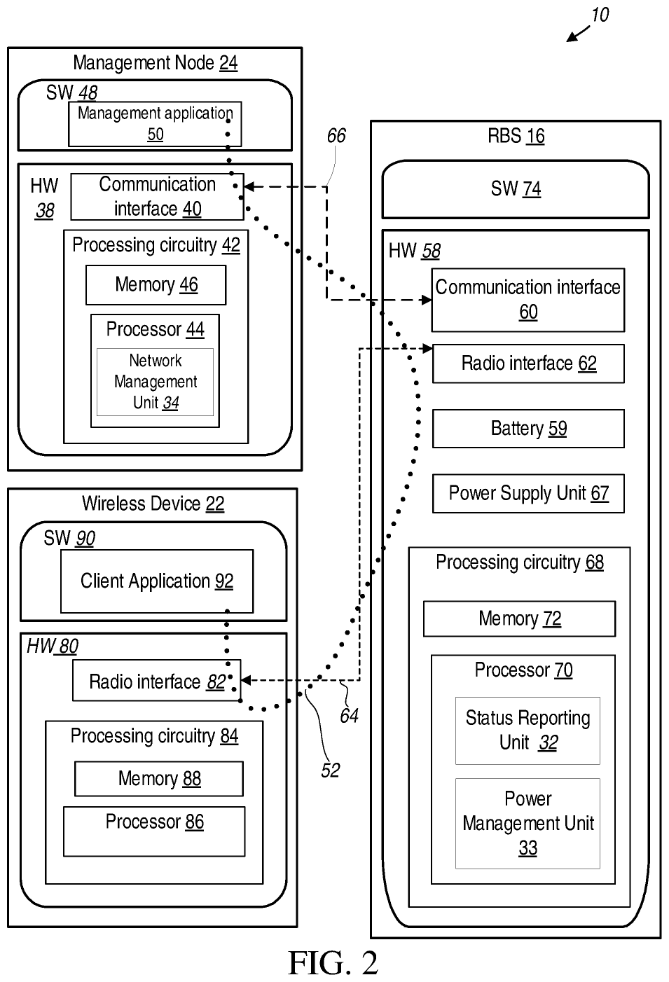

Example implementations, in accordance with an embodiment, of the WD 22, RBS 16 and management node 24 discussed in the preceding paragraphs will now be described with reference to FIG. 2. In a communication system 10, a management node 24 comprises hardware (HW) 38 including a communication interface 40 configured to set up and maintain a wired or wireless connection with an interface of a different communication device of the communication system 10. The management node 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by management node 24. Processor 44 corresponds to one or more processors 44 for performing management node 24 functions described herein. The management node 24 includes memory 46 that is configured to store data, programmatic software code and/or other information described herein. In some embodiments, the software 48 and/or the management application 50 may include instructions that, when executed by the processor 44 and/or processing circuitry 42, causes the processor 44 and/or processing circuitry 42 to perform the processes described herein with respect to management node 24. The instructions may be software associated with the management node 24.

The software 48 may be executable by the processing circuitry 42. The software 48 includes a management application 50. The management application 50 may be operable to provide a service to a remote user, such as a WD 22 connecting via an OTT connection 52 terminating at the WD 22 and the management node 24. In providing the service to the remote user, the management application 50 may provide user data which is transmitted using the OTT connection 52. The “user data” may be data and information described herein as implementing the described functionality. In one embodiment, the management node 24 may be configured for providing control and functionality to a service provider and may be operated by the service provider or on behalf of the service provider. The processing circuitry 42 of the management node 24 may enable the management node 24 to observe, monitor, control, transmit to and/or receive from the RBS 16 and or the wireless device 22 and/or a third-party, such as a power grid/utility operator. The processing circuitry 42 of the management node 24 may include a network management unit 34 configured to enable the service provider to observe/monitor/control/transmit to/receive signaling from the RBS 16 and/or a power grid/utility operator, such as determining which RBSs 16 to assign to participate in ancillary services and at which times (e.g., based on an optimization model), determining signaling for assigning the RBSs 16 to participate, determining profiles for the RBSs 16 for controlling their operation in providing ancillary services, activating/deactivating/controlling the RBSs 16 before, during, and after the participation in ancillary services, and/or generating a report based on the provision of ancillary services (e.g., to send the report to the utility operator to receive payment for the provision of ancillary services).

The communication system 10 further includes an RBS 16 provided in a communication system 10 and including hardware 58 enabling it to communicate with the management node 24 and with the WD 22. The hardware 58 may include one or more batteries 59 (collectively referred to as battery 59), for storing energy, e.g., as a backup power supply for the RBS 16. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the RBS 16. The radio interface 62 may be formed as or may include, for example, one or more RF transmitters, one or more RF receivers, and/or one or more RF transceivers. The communication interface 60 may be configured to facilitate a connection 66 to the management node 24. The connection 66 (which may be used to transmit one or more synchronization signals, such as control signaling indicating one or more operation settings/profiles) may be direct or it may pass through a core node 14 of the communication system 10 and/or through one or more intermediate networks 30 outside the communication system 10. The hardware may include a power supply unit 67 for managing the charging and discharging of power from the battery, the receiving of power from an external source (e.g., the power grid), monitoring power consumption/battery state/SoC, etc., based on control signals received from the power management unit 33/management node 24/network management unit 34/etc.

In the embodiment shown, the hardware 58 of the RBS 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the RBS 16 further has software 74 stored internally in, for example, memory 72, or stored in external memory (e.g., database, storage array, network storage device, etc.) accessible by the RBS 16 via an external connection. The software 74 may be executable by the processing circuitry 68. The processing circuitry 68 may be configured to control any of the methods and/or processes described herein and/or to cause such methods, and/or processes to be performed, e.g., by RBS 16. Processor 70 corresponds to one or more processors 70 for performing RBS 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to RBS 16. For example, processing circuitry 68 of the RBS 16 may include status reporting unit 32 configured to monitor and/or report one or more conditions/states/requirements etc. associated with the RBS 16, such as a hardware state (e.g., battery condition/power levels/SoC), traffic load information (e.g., actual or predicted communication requirements, such as a predicted traffic/signaling load on the RBS 16 in a particular time slot, based on historical data, wireless device 22 signaling, etc.), geographic information (e.g., location coordinates, proximity to other RBSs 16, proximity to a particular power grid, etc.), capability information (e.g., latency of signaling within the RBS 16) etc. The processing circuitry 68 may also include power management unit 33 configured to control power supplied to and/or from one or more hardware components of RBS 16, e.g., based on signaling received from the management node 24, based on the status of the battery 59, based on an actual or predicted traffic load, etc.

The communication system 10 further includes the WD 22 already referred to. The WD 22 may have hardware 80 that may include a radio interface 82 configured to set up and maintain a wireless connection 64 with an RBS 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the management node 24. In the management node 24, an executing management application 50 may communicate with the executing client application 92 via the OTT connection 52 terminating at the WD 22 and the management node 24. In providing the service to the user, the client application 92 may receive request data from the management application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the RBS 16, WD 22, and management node 24 may be as shown in FIG. 2 and independently, the surrounding network topology may be that of FIG. 1.

In some embodiments, the hardware of core node 14 (not shown in FIG. 2) may be similar to that of RBS 16 and/or management node 24.

In FIG. 2, the OTT connection 52 has been drawn abstractly to illustrate the communication between the management node 24 and the wireless device 22 via the RBS 16, without explicit reference to any intermediary devices and the precise routing of messages via these devices. Network infrastructure may determine the routing, which it may be configured to hide from the WD 22 or from the service provider operating the management node 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the RBS 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the management node 24 and WD 22, in response to variations in the measurement results. The measurement procedure and/or the network functionality for reconfiguring the OTT connection 52 may be implemented in the software 48 of the management node 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90, 74 may compute or estimate the monitored quantities. The reconfiguring of the OTT connection 52 may include message format, retransmission settings, preferred routing etc.; the reconfiguring need not affect the RBS 16, and it may be unknown or imperceptible to the RBS 16. Some such procedures and functionalities may be known and practiced in the art. In certain embodiments, measurements may involve proprietary WD signaling facilitating the management computer's 24 measurements of throughput, propagation times, latency and the like. In some embodiments, the measurements may be implemented in that the software 48, 90, 74 causes messages to be transmitted, in particular empty or ‘dummy’ messages, using the OTT connection 52 while it monitors propagation times, errors, etc.

Thus, in some embodiments, the management node 24 includes processing circuitry 42 configured to provide user data and a communication interface 40 that is configured to forward the user data to a cellular network for transmission to the WD 22. In some embodiments, the cellular network also includes the RBS 16 with a radio interface 62. In some embodiments, the RBS 16 is configured to, and/or the RBS 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the management node 24 includes processing circuitry 42 and a communication interface 40 that is configured to a communication interface 40 configured to receive user data originating from a transmission from a WD 22 to an RBS 16. In some embodiments, the WD 22 is configured to, and/or comprises a radio interface 82 and/or processing circuitry 84 configured to perform the functions and/or methods described herein for preparing/initiating/maintaining/supporting/ending a transmission to the RBS 16, and/or preparing/terminating/maintaining/supporting/ending in receipt of a transmission from the RBS 16.

Although FIGS. 1 and 2 show various “units” such as status reporting unit 32, power management unit 33, and network management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

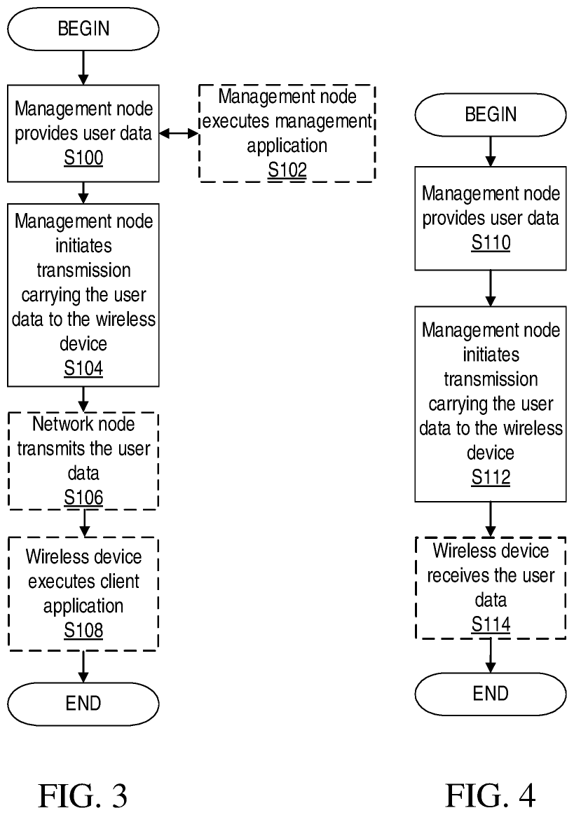

FIG. 3 is a flowchart illustrating an example method implemented in a communication system, such as, for example, the communication system of FIGS. 1 and 2, in accordance with one embodiment. The communication system may include a management node 24, an RBS 16 and a WD 22, which may be those described with reference to FIG. 2. In a first step of the method, the management node 24 provides user data (Block S100). In an optional substep of the first step, the management node 24 provides the user data by executing a management application, such as, for example, the management application 50 (Block S102). In a second step, the management node 24 initiates a transmission carrying the user data to the WD 22 (Block S104). In an optional third step, the RBS 16 transmits to the WD 22 the user data which was carried in the transmission that the management node 24 initiated, in accordance with the teachings of the embodiments described throughout this disclosure (Block S106). In an optional fourth step, the WD 22 executes a client application, such as, for example, the client application 92, associated with the management application 50 executed by the management node 24 (Block S108).

FIG. 4 is a flowchart illustrating an example method implemented in a communication system, such as, for example, the communication system of FIG. 1, in accordance with one embodiment. The communication system may include a management node 24, an RBS 16 and a WD 22, which may be those described with reference to FIGS. 1 and 2. In a first step of the method, the management node 24 provides user data (Block S110). In an optional substep (not shown) the management node 24 provides the user data by executing a management application, such as, for example, the management application 50. In a second step, the management node 24 initiates a transmission carrying the user data to the WD 22 (Block S112). The transmission may pass via the RBS 16, in accordance with the teachings of the embodiments described throughout this disclosure. In an optional third step, the WD 22 receives the user data carried in the transmission (Block S114).

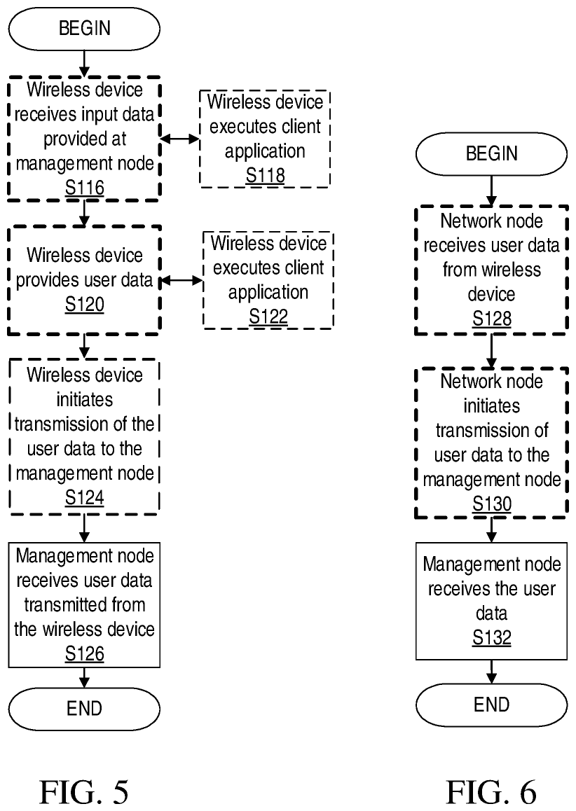

FIG. 5 is a flowchart illustrating an example method implemented in a communication system, such as, for example, the communication system of FIG. 1, in accordance with one embodiment. The communication system may include a management node 24, an RBS 16 and a WD 22, which may be those described with reference to FIGS. 1 and 2. In an optional first step of the method, the WD 22 receives input data provided by the management node 24 (Block S116). In an optional substep of the first step, the WD 22 executes the client application 92, which provides the user data in reaction to the received input data provided by the management node 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the management node 24 (Block S124). In a fourth step of the method, the management node 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a management node 24, an RBS 16 and a WD 22, which may be those described with reference to FIGS. 1 and 2. In an optional first step of the method, in accordance with the teachings of the embodiments described throughout this disclosure, the RBS 16 receives user data from the WD 22 (Block S128). In an optional second step, the RBS 16 initiates transmission of the received user data to the management node 24 (Block S130). In a third step, the management node 24 receives the user data carried in the transmission initiated by the RBS 16 (Block S132).

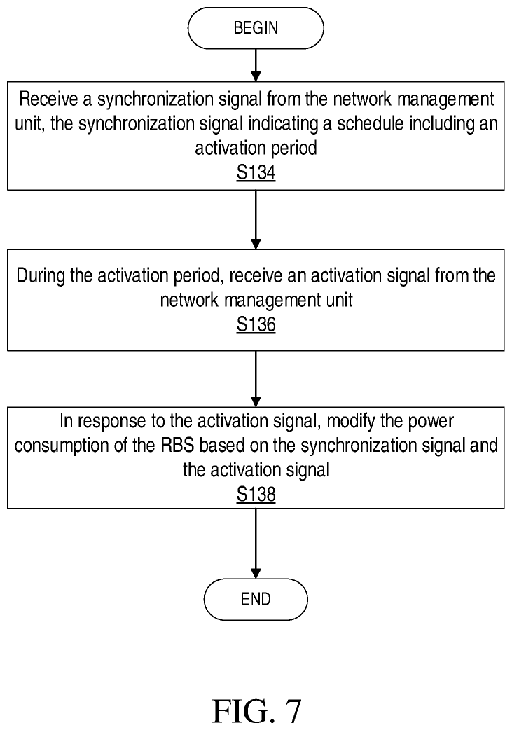

FIG. 7 is a flowchart of an example process in an RBS 16 for FCR operation according to some embodiments of the present disclosure. One or more blocks described herein may be performed by one or more elements of RBS 16 such as by one or more of processing circuitry 68 (including the status reporting unit 32 and/or power management unit 33), processor 70, radio interface 62, communication interface 60, battery 59, and/or power supply unit 67. RBS 16 is configured to receive (Block S134) a synchronization signal from the network management unit 34 (e.g., management node 24) where the synchronization signal indicating a schedule including an activation period. RBS 16 is configured to receive (Block S136), during the activation period, an activation signal from the network management unit 34. RBS 16 is configured to modify (Block S138), in response to the activation signal, the power consumption of the RBS 16 based on the synchronization signal and the activation signal.

In some embodiments of the present disclosure, the transmission of the synchronization signal, including the AS profile, to the RBSs 16 of each cluster occurs prior to the active hour, the AS profile optionally including a profile control, the profile control indicating at least one of: synchronization of the RBS 16 in response to every demand from the network management unit to execute the AS profile, and local execution on at least one local controller for executing at least one power modification process based on at least one threshold indicated by the AS profile. In one or more embodiments, when the synchronization signal is sent to the cluster, by sending the profiles and prior to the service hour, the profile may be executed within the hour. Optional profile control may be included in the operation such that a) synchronization occurs on every demand from ENM/OSS executing the profiles b) local execution on local level, on local controllers, and executing based on the various thresholds provided by the profiles occurs.

In one or more embodiments, the synchronization signal indicates an ancillary services, AS, profile, for controlling power consumption of the RBS 16. In one or more embodiments, the AS profile indicates one of a primary cluster 100 and a standby cluster 102 to which the RBS 16 is assigned, the AS profile being shared by at least one other RBS 16 of the cluster to which the RBS 16 is assigned. In one or more embodiments, the AS profile indicates a standby cluster 102 to which the RBS 16 is assigned where the RBS 16 is further configured to receive an updated synchronization signal from the network management unit 34 indicating an updated AS profile, the updated AS profile indicating a reassignment to a primary cluster 100, and the reassignment is associated with at least one fault condition of another radio base station 16 assigned to the primary cluster 100.

In one or more embodiments, the RBS 16 is further configured to: determine a status report indicating a condition of the RBS 16; and cause transmission of the status report to the network management unit 34 where the synchronization signal is determined based on the status report. In one or more embodiments, the activation signal indicates a Frequency Containment Reserve, FCR, Down Regulation event where the modifying of the power consumption by the RBS 16 includes reducing the power supplied from the power grid to the RBS 16, from utility operator. In one or more embodiments, the RBS 16 includes a battery 59 where the reducing of the power supplied from the power grid includes switching from the power supplied by the power grid to power supplied by the battery 59. In one or more embodiments, the synchronization signal indicates a first threshold and a second threshold lower than the first threshold where the schedule includes a first period prior to the activation period, and the RBS 16 is further configured to: maintain the battery 59 charge above the first threshold during the first period; and decrease the battery 59 charge to the second threshold during the activation period based on the activation signal indicating an FCR-Down Regulation event.

In one or more embodiments, the activation signal indicates an FCR-Up Regulation event, the modifying of the power consumption by the RBS 16 including increasing the power supplied by the power grid to the RBS 16. In one or more embodiments, the RBS 16 includes a battery 59, the increasing of the power supplied from the power grid including charging the battery 59. In one or more embodiments, the synchronization signal indicates a first threshold and a second threshold higher than the first threshold where the schedule includes a first period prior to the activation period, and the RBS 16 is further configured to: maintain the battery 59 charge below the first threshold during the first period; and increase the battery 59 charge to the second threshold during the activation period based on the activation signal indicating an FCR-Up Regulation event.

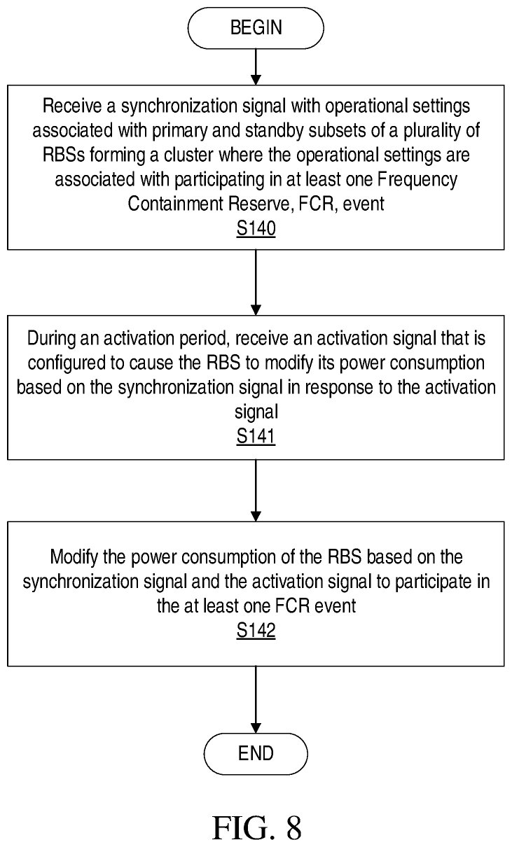

FIG. 8 is a flowchart of another example process in an RBS 16 for FCR operation according to some embodiments of the present disclosure. The RBS 16 is configured to be switchable between power from a power grid and power from a plurality of backup battery units associated with the RBS 16. One or more blocks described herein may be performed by one or more elements of RBS 16 such as by one or more of processing circuitry 68 (including the status reporting unit 32 and/or power management unit 33), processor 70, radio interface 62, communication interface 60, battery 59, and/or power supply unit 67. RBS 16 is configured to receive (Block S140) a synchronization signal with operational settings associated with primary and standby subsets of a plurality of RBSs 16 forming a cluster where the operational settings being associated with participating in at least one Frequency Containment Reserve, FCR, event. RBS 16 is configured to, during an activation period, receive (Block S141) an activation signal that is configured to cause the RBS 16 to modify its power consumption based on the synchronization signal in response to the activation signal. RBS 16 is configured to modify (Block S142) the power consumption of the RBS 16 based on the synchronization signal and the activation signal to participate in the at least one FCR event.

According to one or more embodiments, the RBS 16 is part of one of the primary subset and standby subsets of the plurality of RBSs 16. According to one or more embodiments, the activation signal indicates an FCR-Down event for the RBS 16 to participate in, the modifying of the power consumption by the RBS 16 including reducing the power used from the power grid by the RBS 16. According to one or more embodiments, the activation signal indicates an FCR-Up event for the RBS 16 to participate in, the modifying of the power consumption by the RBS 16 including increasing the power used from the power grid by the RBS 16 by, at least in part, charging at least one of the plurality of backup battery units.

According to one or more embodiments, the synchronization signal is received by the RBS 16 prior to an active time period where the processing circuitry 68 is further configured to: execute the operational settings within the active time period where the operational settings includes a profile control, and the profile control indicates at least one of synchronization of the RBS 16 in response to every demand from the management node 24 to execute the operational settings, local execution on at least one local controller, and execute at least one power modification process based on at least one threshold indicated by the operational settings.

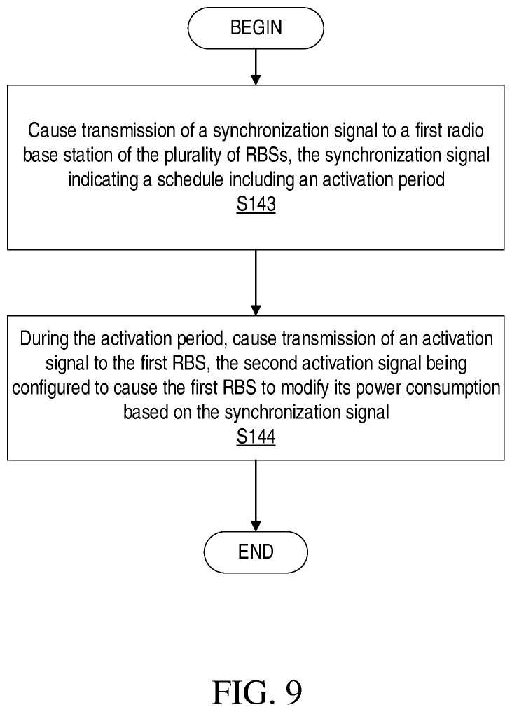

FIG. 9 is a flowchart of an example process in a management node 24 for FCR operation according to some embodiments of the present disclosure. One or more blocks described herein may be performed by one or more elements of management node 24 such as by one or more of processing circuitry 42 (including the network management unit 34), processor 44 and/or communication interface 40. Management node 24 (e.g., network management unit 34) is configured to cause transmission (Block S143) of a synchronization signal to a first RBS 16 of the plurality of RBSs 16 where the synchronization signal indicates a schedule including an activation period. Management node 24 (e.g., network management unit 34) is configured to cause transmission (Block S144), during the activation period, of an activation signal to the first RBS 16 where the activation signal is configured to cause the first RBS 16 to modify its power consumption based on the synchronization signal

In one or more embodiments, the network management unit 34 (e.g., management node 24) is further configured to: receive an indication from the power grid operator indicating a bidding schedule and a Frequency Containment Reserve, FCR, configuration; and determine, based on the bidding schedule and the FCR configuration, a primary cluster 100 of the plurality of RBSs 16 for participating in FCR service during an active period of the bidding schedule where the primary cluster 100 includes the first RBS 16. In one or more embodiments, the synchronization signal indicates an ancillary services, AS, profile, for controlling power consumption of the first RBS 16. In one or more embodiments, the AS profile is shared by the RBSs 16 of the primary cluster 100.

In one or more embodiments, the network management unit 34 being further configured to: determine, based on the bidding schedule and the FCR configuration, a standby cluster 102 of the plurality of RBSs 16 different from the primary cluster 100, the standby cluster 102 including a second RBS 16; receive a status report from the first RBS 16 indicating a fault in the first RBS 16; and based on the received status report, substitute the first RBS 16 with the second RBS 16 by: causing transmission of a deactivation indication to the first RBS 16 configured to cause the first RBS 16 to ignore future activation signals; and causing transmission of the AS profile to the second RBS 16 indicating a reassignment of the second RBS 16 from the standby cluster 102 to the primary cluster 100. In one or more embodiments, the determining of the standby cluster 102 of the plurality of RBSs 16 is based on a proximity of the RBSs 16 of the standby cluster 102 to at least one RBS 16 of the primary cluster 100. In one or more embodiments, the activation signal indicates an FCR-Down Regulation event, the modifying of the power consumption by the first RBS 16 including reducing the power supplied from the power grid to the first RBS 16.

In one or more embodiments, the first RBS 16 includes a battery 59 where the reducing of the power supplied from the power grid includes switching from the power supplied by the power grid to power supplied by the battery 59. In one or more embodiments, the synchronization signal indicates a first threshold and a second threshold lower than the first threshold where the schedule includes a first period prior to the activation period where the synchronization signal is configured to cause the first RBS 16 to: maintain the battery 59 charge above the first threshold during the first period; and decrease the battery 59 charge to the second threshold during the activation period based on the activation signal indicating an FCR-Down Regulation event. In one or more embodiments, the activation signal indicates an FCR-Up Regulation event where the modifying of the power consumption by the first RBS 16 includes increasing the power supplied by the power grid to the first RBS 16.

In one or more embodiments, the first RBS 16 includes a battery 59 where the increasing of the power supplied from the power grid includes charging the battery 59. In one or more embodiments, the synchronization signal indicates a first threshold and a second threshold higher than the first threshold where the schedule includes a first period prior to the activation period and where the synchronization signal causes the first RBS 16 to: maintain the battery 59 charge below the first threshold during the first period; and increase the battery 59 charge to the second threshold during the activation period based on the activation signal indicating an FCR-Up Regulation event. In one or more embodiments, determining the plurality of RBSs 16 to assign to the primary cluster 100 is based on an optimization model where the optimization model is configured to at least one of: maximize profit; minimize disruption to quality of service; minimize degradation of the battery 59; and minimize penalties from the power grid operator.

In some embodiments, the synchronization signal may be sent to a cluster (e.g., primary cluster 100 or standby cluster 102), e.g., by sending the profile(s) to one or more RBS 16, prior to the service/active hour. The profile(s) may be executed within the hour by one or more RBS 16. Optional profile control may be included in the operation, such as a) synchronizing on every demand from the network management unit 34 (e.g., an ENM/OSS) executing the profiles; and/or b) local execution on local level, on local controllers (e.g., processing circuitry 68 of RBS 16), and executing based on the various thresholds provides by the profile(s).

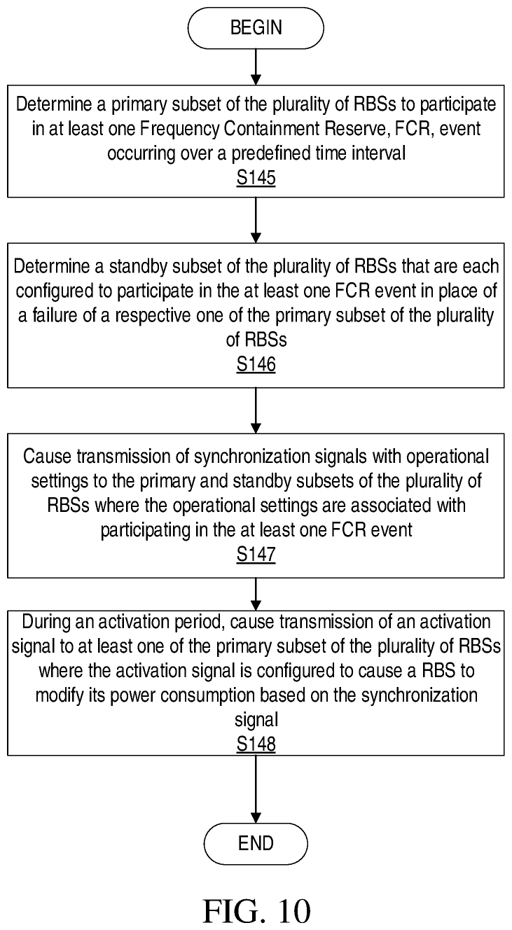

FIG. 10 is a flowchart of another example process in a management node 24 for FCR operation according to some embodiments of the present disclosure. One or more blocks described herein may be performed by one or more elements of management node 24 such as by one or more of processing circuitry 42 (including the network management unit 34), processor 44 and/or communication interface 40. Management node 24 is configured to communicate with a power grid operator and with a plurality of RBSs 16 where each of the plurality of RBSs are configured to be switchable between power from a power grid and power from a respective plurality of backup battery units associated with the RBS 16. Management node 24 (e.g., network management unit 34) is configured to determine (Block S145) a primary subset of the plurality of RBSs 16 to participate in at least one Frequency Containment Reserve, FCR, event occurring over a predefined time interval. Management node 24 is configured to determine (Block S146) a standby subset of the plurality of RBS 16 that are each configured to participate in the at least one FCR event in place of a failure of a respective one of the primary subset of the plurality of RBSs; Management node 24 is configured to cause (Block S147) transmission of synchronization signals with operational settings to the primary and standby subsets of the plurality of RBSs 16 where the operational settings are associated with participating in the at least one FCR event. Management node 24 is configured to, during an activation period, cause (Block S148) transmission of an activation signal to at least one of the primary subset of the plurality of RBSs 16 where the activation signal is configured to cause a RBS 16 to modify its power consumption based on the synchronization signal.

According to one or more embodiments, the determining of the primary and standby subsets of the plurality of RBSs 16 is based on an optimization model that maximizes availability for participating in at least one FCR event and energy compensation event while minimizing a penalty cost for failing to meet energy requirements for at least one FCR event, battery degradation cost, a physical range of the primary and standby subsets of the plurality of RBSs 16, and a number of RBSs 16 in the primary and standby subsets of the plurality of RBSs 16.

According to one or more embodiments, the optimization model iteratively generates a set of operational settings according to an iterative pricing problem model where the iterative pricing problem model is configured to compute a contribution of FCR-UP event, FCR-DOWN event and estimated battery degradation for participating in the at least one FCR event for a respective RBS 16 at time t where different FCR events for a RBS 16 are considered, and where the FCR-DOWN event corresponds to a reduction in power supplied from the power grid to at least one of the primary subset of the plurality of RBSs 16, and where the FCR-UP event corresponds to an increase in power supplied by the power grid to at least one of the primary subset of the plurality of RBSs 16.

According to one or more embodiments, the iterative pricing problem model output is a RBS configuration among a plurality of RBS configurations having a least cost to participate in the at least one FCR event compared to the cost associated with the remaining RBS configurations, and where the least cost is based on availability to participate in at least one FCR event, compensation for participating in at least one FCR event, penalty cost for failing to meet energy requirements for at least one FCR event, battery degradation cost, physical range of the primary and standby subsets of the plurality of RBSs 16, and number of RBSs 16 in the primary and standby subsets of the plurality of RBSs 16.

According to one or more embodiments, the battery degradation cost is estimated based on: linearizing a battery degradation curve that maps a maximum number of battery cycles to a depth of discharge of the battery, segmenting the linearized battery degradation curve, and determining a degradation rate for each segment of the linearized battery degradation curve for each event in a battery degradation model.

According to one or more embodiments, the at least one FCR event corresponds to a plurality of FCR events occurring over the predefined time interval, where a first portion of the primary subset of the plurality of RBSs 16 is scheduled to participate in a first FCR event of the plurality of FCR events, and a second portion of the primary subset of the plurality of RBSs 16 is scheduled to participate in a second FCR event of the plurality of FCR events, and where the first portion of the primary subset of the plurality of RBSs 16 is different from the second portion.

Having described the general process flow of arrangements of the disclosure and having provided examples of hardware and software arrangements for implementing the processes and functions of the disclosure, the sections below provide details and examples of arrangements for a wireless network including RBSs 16 to provide ancillary services, such as FCR services, to a power grid.

One or more management node 24 functions described below may be performed by one or more of network management unit 34, processing circuitry 42, processor 44, communication interface 40, etc. That is, while some functions are described as being performed by network management unit 34, these functions may be performed by management node 24 and/or another element in management node 24. One or more RBS 16 functions described below may be performed by one or more of processing circuitry 68, status reporting unit 32, power management unit 33, radio interface 62, communication interface 60, etc.

The network architecture disclosed herein may enable power supply units 67 (PSUs 67) of RBSs 16 in multiple FCR “zones” (e.g., a cluster of RBSs 16 participating in the FCR), distributing FCR control signals to multiple RBSs 16, to support the power grid with FCR service, according to principles of the present disclosure. Thus, acting as an entity (from the utility perspective) and distributing the FCR signal to multiple Radio Base Stations 16 (RBSs), it may be feasible to meet many or all minimum requirements for the service and, in this way, support a power grid with FCR service by reusing existing CSP assets. The PSU 67 may have a connection (e.g., a direct connection or an indirect connection) to the power grid, where the connection is in accordance with local power grid specifications (e.g., a 230 VAC power grid in Sweden). The PSU 67 has a connection to one or more components of hardware 58. For example, the PSU 67 has a connection to the battery 59, e.g., for providing power to charge the battery. The PSU 67 has a connection to the radio interface 62, which may include radio antennas and other radio hardware, for example. PSU 67 is controlled by signals received from the processing circuitry 68, e.g., from power management unit 33 or similar controller, which in turn may be determined based on control signals (such as a profile) received by RBS 16 from management node 24/network management unit 34.

An RBS 16 may provide mobile service to wireless devices 22 (e.g., via radio interface 62), while the network management unit 34 at the same time may provide the radio scheduling and the orchestration of both mobile radio traffic and scheduling for FCR (or any other ancillary service).

Some embodiments provide a cloud operation system and functionality to efficiently manage a RAN network consisting of multiple RBSs 16/network nodes connected to the power grid and capable of participating in ancillary services/FCR.

This approach controls and triggers various activities prior to service activation, such as:

In the day-ahead, identifying the optimum cluster (e.g., a group of RBSs 16/network nodes) for one bidding period (e.g., bidding hour) and optionally dividing the cluster into a primary cluster and a backup/standby cluster. The primary cluster participates actively in the service and the standby cluster works as an extra asset (e.g., for redundancy purposes).

To indicate/determine, using a modeling approach, the most profitable time slot(s) to participate in the next day (considering, e.g., energy storage/battery degradation, price/expected revenues, potential penalties, etc.).

From the perspective of the RBS 16 control, provide synchronizing signals, e.g., with profiles, for each bidding period (e.g., bidding hour), which may be based on/associated with clusters (e.g., primary and standby clusters) that are given the same identity (in relation to the bidding cluster), forming and operating as one single entity.

Internally generate a secondary identity that identifies elements of the primary and the standby cluster, where different RBSs 16 can be activated and operate as one entity (which is required to participate in AS/FCR) or several entities within the cluster, forming the control strategy for primary and standby RBSs 16.

The method further determines and manages the clusters, sending a synchronized activation signal prior to the bidding hour (or within the hour) to activate and deactivate multiple RBSs 16 as well as deliver the AS/FCR signals. The signals may also be sent prior to the activation, or on the day-ahead.

The method supports the CSPs/MNOs willing to provide AS/FCR and to enable an extra revenue stream. The method finds/predicts the most profitable cluster (e.g., in comparison to one or more other clusters) for a bidding hour to maximize the operator's revenue. The method allows the identification of/prediction of the most profitable time slot (e.g., in comparison to one or more other time slots) to participate in the next day.

For each bidding hour, the method may also select one (or more) standby cluster to operate and one as a backup, increasing the reliability of the system described herein.

The method considers one or more elements present in a RAN system, including the battery and its degradation effect.

The method enables synchronization signals, where the signals may contain different information such as site profiles, power profiles, cluster profiles, battery profile, capacity profile, control profile (PSU 67, battery 59, radio) etc. for faster reaction time and preparedness of the RBS 16, prior to and during the active service hour.

Clusters may be formed, depending on the need and operation, e.g., based on 1) power levels, 2) latency, 3) location (proximity to one another), 4) performance, 5) battery capacity (RBS battery 59 capacity may vary in different locations/different RBS 16s/etc.), 6) PSU 67 capacity, 7) Radio interface 62 power consumption, 8) time of day, 9) cost of power, 10) traffic needs, etc.

The RBSs 16 batteries 59 provide backup power in case of a power outage or if a failure occurs for the RBS 16 functionality. However, in countries where power grids are very stable, power sources 67 and batteries 59 may be underutilized, or it may be utilized only a few times per year, and those assets may be exploited by a CSP/MNO, e.g., by providing AS/FCR, as described herein.

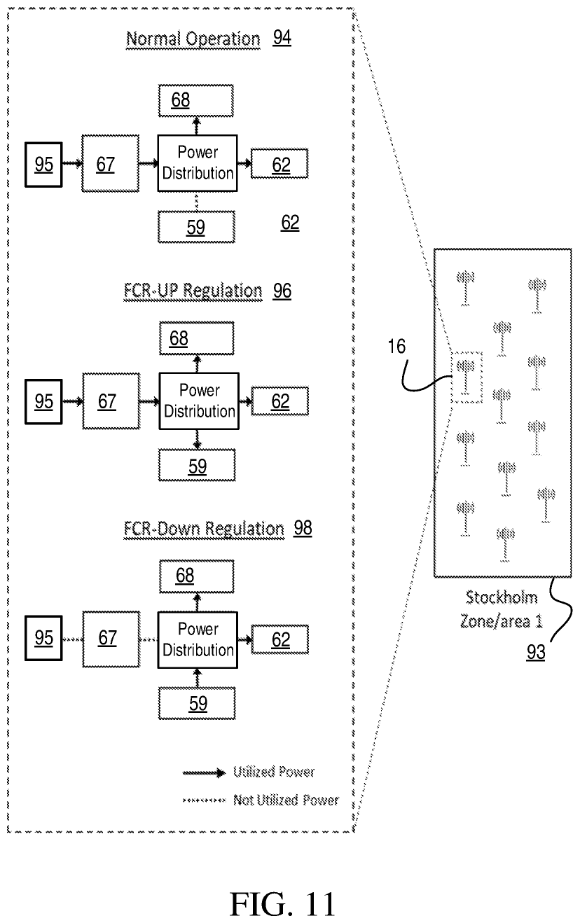

FIG. 11 depicts an example of a group of RBSs 16 providing FCR-N(or alternatively for providing FCR-D), considering both up and down regulation based on requests, that are: normal operation, up-regulation request and down-regulation. In one or more embodiments, normal operation may refer to no participating in FCR-N These requests may be transmitted as signals sent by the utility provider (e.g., at the level of seconds), and/or such signals may be locally generated (e.g., by one or more RBS 16, in response to detected conditions, etc.). For example, one or more of a set of RBSs 16 belonging to a particular zone 93 (in this example, referred to as “Stockholm Zone/area 1”) participates in FCR-N provision.

Example operation prior to an FCR hour: In one or more embodiments, the RBS 16 may be configured (e.g., based on a profile/control signals received from management node 24) to charge battery 59 up to a threshold (e.g., 80% of charge capacity), where the threshold may vary. For example, during a time period prior to an active hour, the RBS 16 may reduce the threshold (e.g., to 40% of charge capacity), whereas during other periods (e.g., periods during which the price of electricity is relatively less expensive), the threshold may be increased (e.g., to 90% of charge capacity). These thresholds, and when/under what conditions the thresholds apply, may be defined by synchronization signals/profiles received from management node 24. In this way, the network manager may decrease the charge of the battery 59 (thereby increasing the amount of spare battery 59 capacity) so that the battery 59 can absorb some power from the grid 95 during an FCR-Up Regulation event, while also maintaining sufficient charge in battery 59 so that the battery 59 can supply power to the RBS 16 during an FCR-Down Regulation event. These thresholds may be configured on a per-cluster basis (e.g., all RBS 16 in a cluster share the same threshold values), and/or may be configured on a per-RBS 16 basis (e.g., each RBS 16 has its own corresponding threshold values).

Normal operation 94 during, for example, an FCR hour: for normal operation 94, there is no FCR-UP or FCR-Down regulation request received from the power utility and in such case, the RBS 16 may be supplied with power from power grid 95 to, for example, provide RBS functions but without charging/recharging battery 59. FCR-Up Regulation 96: during FCR-Up regulation 96, an up-regulation request is received (e.g., as a signal sent by management node 24, as a signal from the utility operator, as a result of RBS 16 observing a condition in the connection to grid 95, etc.), in which the utility operator requests that the CSP/MNO increase the grid energy consumption.

An increase in energy consumption at the RBS 16 may be achieved by recharging one or more RBS 16 batteries 59. For example, RBS 16 may increase the threshold of battery 59 charging, for example, from 60% to 90% of charge capacity, during the FCR-Up Regulation 96 period so that, if battery 59 was not previously charging (because it was “full” at 60%), battery 59 will now begin charging, thereby increasing overall energy consumption at the RBS 16. Other techniques for increasing the power consumption of RBS 16 during the FCR-Up Regulation 96 event may be utilized. For example, RBS 16 may increase power supplied to the radio interface 62 (e.g., increasing the power of wireless signaling), increase the power supplied to processing circuitry 68, perform one or more maintenance/backup operations which increase power consumption, etc.

FCR-Down Regulation 98: In FCR-Down regulation 98, a down-regulation request is received in which the utility asks the CSP/MNO to decrease the grid energy consumption, which may be achieved by the RBS 16 switching its power supply from the power grid 95 to the battery 59, such that RBS reduces or eliminates its power consumption from the power grid 95 and instead utilizes power from the battery 59. Other techniques for decreasing the power consumption of RBS 16 during the FCR-Down Regulation 98 may be utilized without deviating from the scope of the present disclosure. For example, RBS 16 may decrease power supplied to the radio interface 62 (e.g., decrease the power of wireless signaling), decrease the power supplied to processing circuitry 68, decrease the threshold for battery 59 maximum charge (stopping the battery 59 from charging and thereby decreasing overall energy consumption), etc.

In order to activate an ancillary service and manage the energy system, a cloud-based network manager, such as network management unit 34 in management node 24, may be used in some embodiments of the present disclosure. For example, external signals regarding ancillary services/FCR service may be received from a utility company (e.g., a TSO), and all communications between the utility and RBSs 16 are handled via the management node 24 (e.g., via network management unit 34) together with RBS 16 (e.g., via power management unit 33 and/or status reporting unit 32) enabling such functionality.

Frequent monitoring may be required to meet AS/FCR service requirements, e.g., at the scale of one minute, for improved accuracy and control, from the network management unit 34.

Alarms during operation may be raised by RBS 16 and may be handled directly, with respective action from the network management unit 34. Local control functionality (e.g., implemented at power management unit 33) may have a shorter time scale, such as 1 second.

The synchronization signal may be sent to a cluster (e.g., primary cluster 100 or standby cluster 102), e.g., by sending the profile(s) to one or more RBS 16, prior to the service/active hour. The profile(s) may be executed within the hour by one or more RBS 16. Optional profile control may be included in the operation, such as a) synchronizing on every demand from the network management unit 34 (e.g., an ENM/OSS) executing the profiles; and/or b) local execution on local level, on local controllers (e.g., processing circuitry 68 of RBS 16), and executing based on the various thresholds provides by the profile(s).

In one embodiment, functionality inside management node 24 (e.g., network management unit 34) enables the orchestration of RBSs 16 when providing various FCR services. Some or all FCR service requirements may be embedded inside this function, and/or may be locally activated and operated on each site/RBS 16 or cluster of sites/RBSs 16.

### Primary/Standby Cluster Determination and Operation

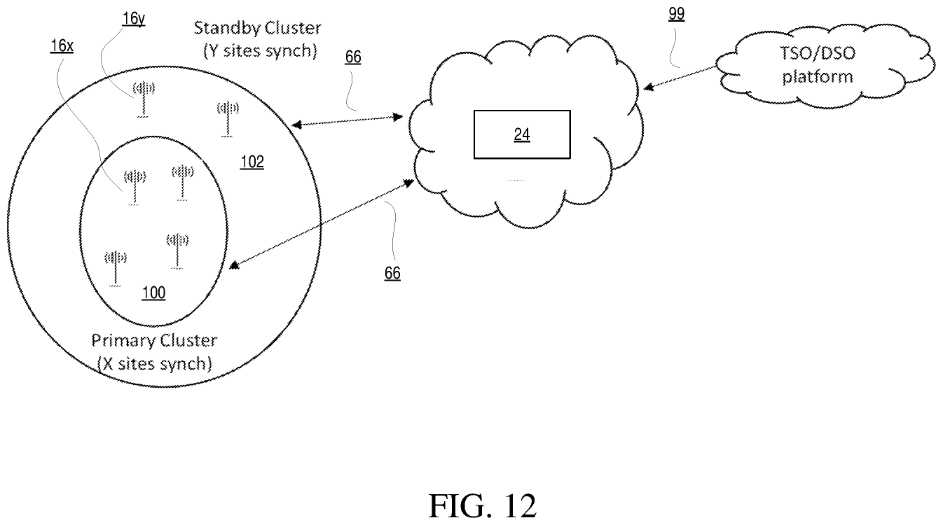

As depicted in FIG. 12, management node 24 receives FCR signaling (e.g., utility operator signaling 99) from a third-party utility operator (e.g., from a TSO/DSO platform operating in the cloud, the details of which are beyond the scope of the present disclosure). Utility operator signaling 99 may include, for example, an TSO/DSO activation signal (for turning on/off FCR service), may indicate one or more AS/FCR requirements, may indicate power costs for one or more time periods, may provide scheduling/timing information, penalty information, bidding information, etc. In one embodiment, for each bidding hour, management node 24 (e.g., via network management unit 34) determines two or more clusters, including a primary cluster 100 and standby cluster 102. The primary cluster 100 (e.g., a service cluster) may be responsible for answering all FCR requests and policy requirements during a bidding hour, while the standby cluster 102 (e.g., a backup cluster) functions as a redundant asset for backup purposes in case of failure of one or more RBSs 16 of the primary cluster 100. The standby cluster 102 may be important due to unpredictable system faults related to RBS 16 alarms and alarm handling. The primary cluster 100 and standby cluster 102 may be defined/determined on the day before the bidding hour and/or on the day of the bidding hour, and may be activated on the service-day (intra-day). Additional primary clusters 100 and/or additional standby clusters 102 may be utilized without deviating from the scope of the present disclosure.

In one embodiment, management node 24 determines the cluster relation between the primary cluster 100 and standby cluster 102.

### Cluster Synchronization and Control of RBS 16

During the bidding hour, service alarms can be raised, and RBSs 16 may, due to various reasons, not be able to deliver the pre-agreed power levels subjected to the primary cluster 100. For example, RBS 16x of primary cluster 100 may not be able to reduce power consumption from the power grid 95 (e.g., its battery is empty, its traffic load is too high, etc.), or RBS 16x may not be able to increase power consumption from the power grid 95 (e.g., its battery 59 may be completely full, its traffic load may be too low, etc.). In either case, an alarm may be raised and transmitted to the network manager unit 34 to handle the RBS 16x alarms. To avoid penalties by not meeting power requests, the network manager unit 34 may select one or more other RBSs 16y from the standby cluster 102, which may be pre-defined and ready to be activated, remove the RBS 16x from the primary cluster 100 (and terminate the provision of FCR services by RBS 16x, e.g., by instructing RBS 16x to ignore future FCR activation signals), substitute RBS 16x with the one or more other RBSs 16y from the standby cluster 102 by switching the RBSs 16y from the standby cluster 102 to the primary cluster 100 and activating the FCR service on RBSs 16y, which may include transmitting a profile (or updated profile) and/or other synchronization signals to RBS 16y and/or RBS 16x. Additional RBSs 16 may be determined/selected and added to the standby cluster 102 to replace the RBSs 16y which were switched over to the primary cluster 100.

In another embodiment, the cluster determination (i.e., determining which RBSs 16 to assign to the primary cluster 100 and which RBSs 16 to assign to the standby cluster 102) may be based on an optimization procedure/algorithm, such as a Dantzig-Wolfe decomposition for Mixed Integer Linear Programming (MILP), wherein the objective function is to find the most profitable cluster (e.g., determine which RBSs 16 to assign to primary cluster 100) for the next day bidding hour as well as the most profitable time period (or multiple time periods, depending on the settings) to participate, seeking maximum profit gain and minimal battery degradation without compromising quality of service on the wireless communication network 10.

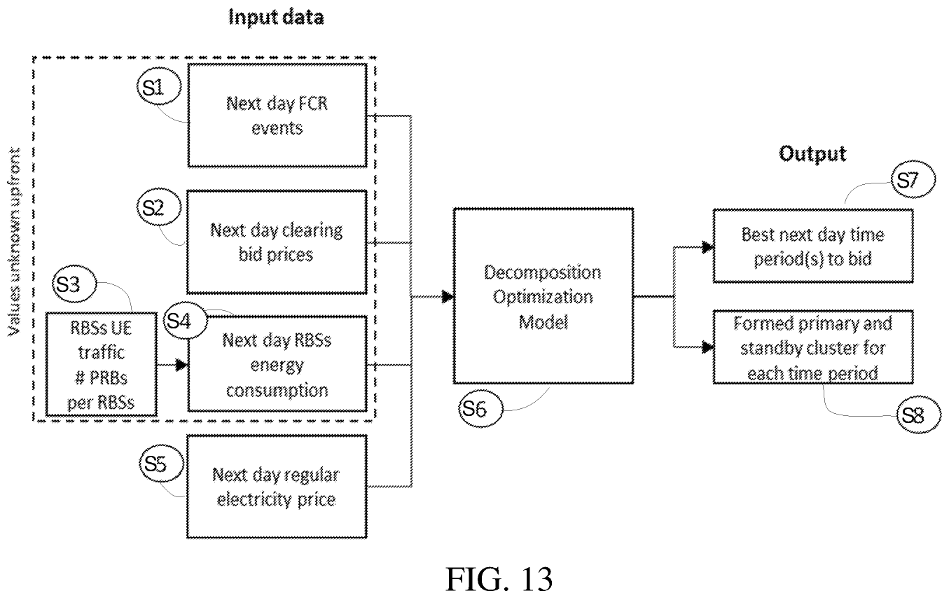

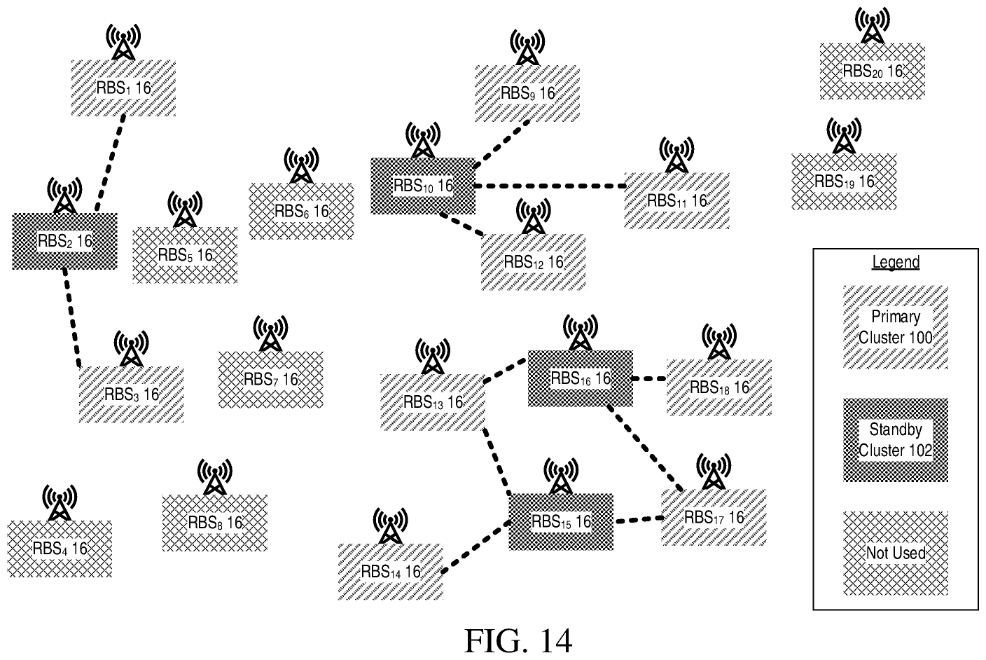

FIG. 13 illustrates a diagram describing the model workflow for an example optimization procedure. In Step S1 (Next day FCR events), grid requests coming from the utility (TSO) during the intraday period are received (e.g., by management node 24). Each FCR request may be received periodically/in intervals (e.g., every 10 seconds) and may indicate the power reduction/increase requested by the grid (e.g., as determined by the third-party utility operator for maintaining the power grid 95 frequency near its nominal value). The indication may provide these power values in Watts (W), which may be proportional to the FCR bidded capacity. In Step S2 (Next day clearing bid prices), clearing bid price(s) for each hour of the next day are determined/predicted (e.g., by management node 24). These values may be unknown upfront and defined only during the auction. In some electricity markets, for example, FCR capacities are auctioned a day-ahead based on timeslots of one hour (for the Swedish electricity market, for instance).

For convenience, embodiments of the present disclosure refer to “day-ahead bidding,” but other electricity markets may utilize different timings (e.g., two days ahead, 12 hours ahead, etc.), and the teachings of the present disclosure are applicable to any electricity market regardless of the particular bidding/FCR timings utilized in that market. Thus, as used herein, “day ahead” may refer to any time period (whether longer or shorter than a day ahead), as defined in a particular electricity market, during which bidding occurs for provision of future ancillary services, such as FCR service.

In Step S3, RBS 16 and/or WD 22 traffic is determined/predicted/indicated (e.g., by management node 24) for a particular time period (e.g., for one or more bidding hours on the following day), which may be indicated/represented as, for example, a number of physical resource blocks, number of connections per RBS 16 (but other parameters/representations may be included/considered). In Step S4 (Next day RBSs energy consumption), energy consumption of each RBS 16 for the next day is predicted/determined (e.g., by management node 24), which may be predicted for each potential bidding hour. These values may be unknown upfront (i.e., during the day ahead period), but may be predicted/estimated (e.g., based on historical traffic data for a particular RBS 16, based on historical clearing bid prices, etc.).

In Step S5 (Next day regular electricity price), electricity prices in the regular energy market in the next day are determined. These values may be indicated the day-ahead by the utility operator. In Step S6, an optimization procedure is performed (e.g., by management node 24), such as according to a decomposition optimization model. In Step S7, the optimization procedure (e.g., as performed by management node 24) determines the best next day time period(s) (e.g., bidding hours) to place bids. In Step S8, the optimization procedure (e.g., as performed by management node 24) determines the (predicted) most profitable primary cluster 100 and standby cluster 102 (e.g., determines which RBSs 16 to assign to each cluster) for one or more of the next day bidding hour(s) as well as the most profitable time period(s) to participate/place bids. The optimization model may dynamically (e.g., in real time) monitor the operation of the primary cluster 100/standby cluster 102 and adjust the parameters of the model accordingly.

As described above, some of the inputs to the optimization model (e.g., one or more of the inputs of Steps S1, S2, S3, and/or S4) may be unknown upfront. Thus, predictions may be made (e.g., by management node 24) in order to apply the optimization model/procedure. The particular techniques for predicting these inputs are beyond the scope of the present disclosure.

FIG. 14 depicts an example network architecture according to some embodiments of the present disclosure. In FIG. 14, twenty RBSs 16 are depicted as belonging to either a primary cluster 100, a standby cluster 102, or neither (i.e., are “Not Used”). The management node 24 may determine clusters (e.g., primary cluster 100, standby cluster 102, additional primary and/or standby clusters, etc.) of RBSs 16 to participate in FCR service, and may determine a primary cluster 100 and a standby cluster 102 for each bidding hour (e.g., determine which RBSs 16 to assign to the primary cluster 100 and which to assign to the standby cluster 102).

Each RBS 16 belonging to the primary cluster 100 is “protected by” (i.e., is associated with) at least one RBS 16 belonging to a standby cluster 102, e.g., the RBS 16 belonging to the standby cluster 102 is designated as a (potential) replacement for the associated RBS 16 of the primary cluster 100 in the event that the RBS 16 of the primary cluster 100 fails. Such associations may be based on cell relations, power consumption, radio traffic, battery capacity, location, etc. These relationships are represented in FIG. 14 by the dashed lines connecting certain RBSs 16 (e.g., the line between RBS₁ 16 of the primary cluster 100 and RBS₂ 16 of the standby cluster 102). In some embodiments, an RBS 16 belonging to the standby cluster 102 may be “shared” by (e.g., associated with) multiple RBSs 16 of the primary cluster 100, under the assumption that only one RBS 16 of the primary cluster is likely to fail at any particular time. In some embodiments, RBS 16s belonging to the standby cluster 102 are selected/determined/associated with one or more RBS 16s belonging to the primary cluster 100 based on proximity (e.g., geographic proximity, logical proximity, etc.) to an RBS 16 of the primary cluster 100 (e.g., a “protected” RBS 16), which may be beneficial, for example, to minimize latency times, to ensure that the RBS 16 belonging to the standby cluster 102 is similar to the RBS 16 of the primary cluster 100, such that when the “protected” RBS 16 of the primary cluster 100 is substituted with the associated RBS 16 of the secondary cluster, minimal disruption occurs. In some embodiments, more than one RBS 16 of the standby cluster 102 may protect (i.e., be associated with) a given RBS 16 of the primary cluster 100 (e.g., according to their battery capacity and SoC), for example, e.g., RBS₁₃ 16 and RBS₁₇ 16 of FIG. 14. The particular assignments of RBSs 16 to a particular cluster may vary for each bidding hour.

In another aspect of the present disclosure, the primary cluster 100 and/or standby cluster 102 is determined/selected so as to fulfill one or more future utility requests, e.g., the standby cluster 102 is selected to have a pre-defined (e.g., by a policy) standby power capacity (e.g., 10% of the bid capacity). Note that this power capacity threshold is merely an example and further, the power capacity threshold may vary, such that 10% may be, for example, a starting number that may increase/decrease based on future predictions/expectations of the operation Policy based operations may set the variable level threshold in various steps, e.g., determined daily or weekly.

In some embodiments, RBSs 16 belonging to a particular cluster may be configured with the same profiles (e.g., received as control/synchronization signals from management node 24). These profiles may define one or more behaviors/conditions/operations/triggers/etc., such as controlling power management unit 33 (e.g., for determining when and how much to charge/discharge battery 59, how much to increase/decrease power by power supply unit 67), controlling status reporting unit 32 (e.g., determining what information to report and when/how often to report it), etc., and these behaviors may be shared by one or more RBSs 16 of a particular cluster.

In another embodiment, the method forming the two clusters gives them the same identity, to be able to belong to the same cluster from the utility's perspective (forming an entity), but internally, each cluster receives a secondary identity to be able to operate and be activated individually. This secondary identification allows the fast replacement of any given active RBS 16 in case of faulty events (to avoid and minimize penalties).

### Profiling and Synchronization

In another embodiment, the clusters may be formed depending on the need and operation, for example, based on power levels, latency, location (proximity to one another), performance, battery capacity (RBS 16 battery 59 capacity varies at different locations), PSU 67 capacity, radio interface 62 power consumption, etc.

Based on the selected profile(s) and/or control signals (e.g., signaled by management node 24 to RBS 16), different technical effects may be realized, e.g., on the operation of the cluster, related to FCR.

### Decomposition Optimization Model

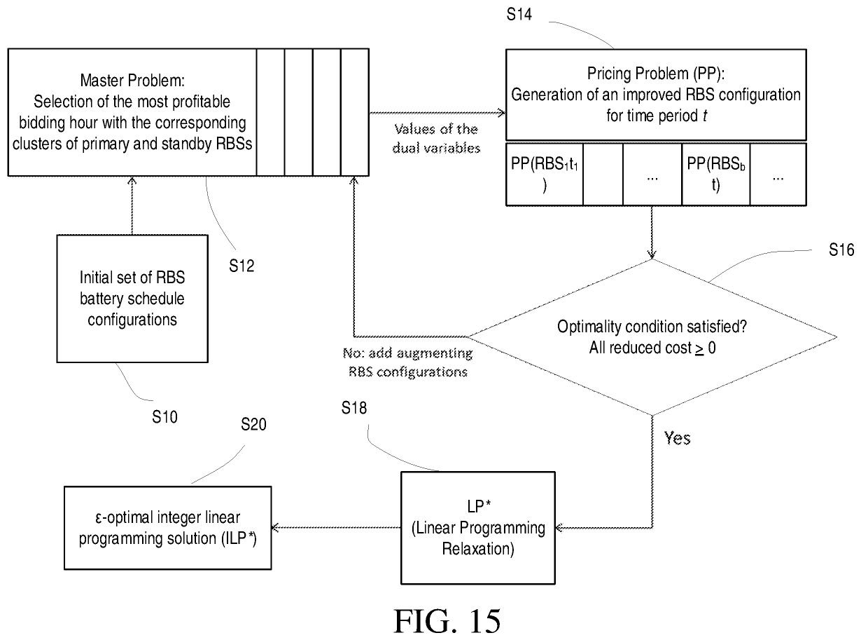

In some embodiments of the present disclosure, in order to at least in part solve the problem of identifying the most profitable one hour bidding (e.g., determining which RBS 16 to assign to which clusters, determining how much to bid, which hours to bid for, etc.), an optimization based on a Dantzig-Wolfe decomposition method for Mixed Integer Linear Programming (MILP) may be utilized. This approach includes a master problem coordinating a set of pricing problems which are solved alternately (as illustrated in the flowchart of FIG. 15 described below). This particular example model tackles only the one bidding hour case (e.g., when the CSP/MNO wants to participate in the next day only in one hour). Other optimization techniques may be utilized without deviating from the scope of the present disclosure.

The master and pricing problem are described below. Battery degradation is detailed below as well.

FIG. 15 depicts an example solution flowchart according to embodiments of the present disclosure. These steps may be performed by management node 24, for example, or by any other entity of system 10. It should be noted that some or all pricing problems may be solved in parallel in order to save computational time. In Step S10, an initial set of RBS 16 battery 59 schedule configurations is determined. In Step S12, the Master Problem: Selection of the most profitable bidding hour with the corresponding clusters of primary cluster 100 and standby cluster 102 for assigning RBSs 16 is performed/solved. The values of the dual variables are provided to Step S14, the pricing problem (PP), in which generation of an improved RBS 16 configuration for time period t is determined. In Step S16, it is determined whether an optimality condition is satisfied, and all reduced cost greater than or equal to 0. If no, then augmenting RBS 16 configurations are added and supplied to the master problem, and the flow proceeds to Step S12 again. If yes, then the flow proceeds to Step S18, linear programming (LP*) relaxation. The flow proceeds to Step S20, where an s-optimal integer linear programming solution (ILP*) is determined/performed.

Master problem: Base Station/Battery Configuration

For a given bidding hour participation, the management node 24 (e.g., via network management unit 34) may identify a set of participating RBSs 16 (with batteries 59) in order to answer FCR requests from the utility operator (e.g., via utility operator signaling 99). However, selected RBSs 16 may not participate in each individual FCR event, but as a whole, must be able to answer all FCR events during the bidding hour (even though not all portions may be used of the demand).

Table 2 below depicts an example of potential RBSs participating in one-hour bidding.

TABLE 2
Example of potential RBSs participation
to FCR events for a single t period.

| | m FCR events (t = 15) | | | | | | |
|---|---|---|---|---|---|---|---|
| Participating RBS 16 | e₁¹⁵ | e₂¹⁵ | e₃¹⁵ | e₄¹⁵ | e₅¹⁵ | . . . | eₘ¹⁵ |
| RBS₁ 16 | 1 | 1 | 1 | 0 | 0 | . . . | 1 |
| RBS₂ 16 | 1 | 0 | 1 | 1 | 1 | . . . | 1 |
| RBS₃ 16 | 0 | 1 | 1 | 1 | 0 | . . . | 1 |
| . . . | . . . | . . . | . . . | . . . | . . . | . . . | . . . |
| RBSₙ 16 | 1 | 0 | 1 | 1 | 1 | . . . | 1 |

Note that, in a single time period t, there may be multiple events to be answered by selected RBSs 16. In addition, the selection of RBSs 16 is divided into primary and standby RBSs 16 (i.e., RBSs 16 assigned to the primary cluster 100 and to the standby cluster 102, respectively, as described herein with respect to FIG. 14). Standby RBSs 16 may be considered “spare” RBSs 16 in the event of one or more of the primary RBSs 16 encountering a failure.

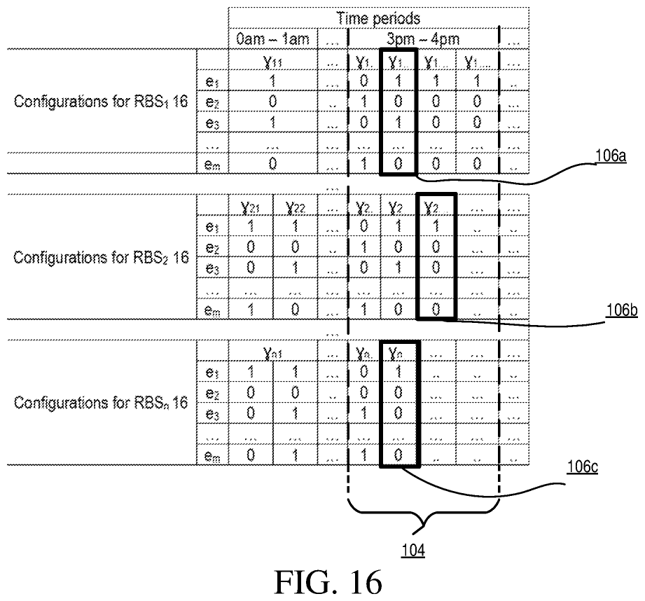

For a given RBS 16 b and a given time period t, a battery configuration γ is defined by the set of FCR events to which the RBS 16 b participates at time t. As an example, as can be seen in FIG. 16, each RBS 16 (e.g., RBS₁ 16, RBS₂ 16, RBS₃ 16) may have different numbers of generated configurations for each time slot (e.g., time slot 104 from 3 μm to 4 μm), where a ‘0’ indicates no participation, and a ‘1’ indicates participation. In the example of FIG. 16, RBS₁ 16 participates in events e₁ and e₃ at time slot 104, while RBS₂ 16 and RBSₙ 16 participate only in event e₁ (e.g., participations 106a, 106b, and 106c).

Such a configuration γ∈Γ is characterized in the model by:
a_{bt}^{γ}=1, if RBS 16 b can participate to bidding at time period t, 0 otherwise.
E_{bt}^{FCR_UC,γ}=energy drained from the grid and stored in the battery 59 of RBS 16 b during hour t (during FCR up request).
E_{bt}^{FCR_DOWN,γ}=reduction in energy grid consumption (obtained by supplying RBS b with its battery) in time period t (during FCR down request).
SoC_{bt}^{γ}=state of charge of the battery 59 of RBS b at the end of time period t.
D_{bt}^{γ}=battery degradation of the battery 59 of RBS b at the end of time period t. See below in formula (48) and in the “Computing the battery degradation” section.

### Parameters

B: Number/set of base stations b.
T: Number of intervals or time-slots t within a market day.
t: One hour time slot index
b: RBS index
e_{b}: Electric energy zone of RBS b (RBS 16 b)
a: Electricity area of RBS b
A_{b}: Usable capacity of E_{b}^{CAP}(in %)
A^{ELEC}: set electric zones a
REQₜ^{FCR-UP}: Sum of FCR up regulation request (in W) at hour t
REQₜ^{FCR-DOWN}: Sum of FCR down regulation request (in W) at hour t
P_{b}^{ch}: Ability of the battery of RBS b to absorb energy
P_{b}^{dc}: Ability of the battery of RBS b to discharge energy
p_{b}^{REP}: Battery replacement cost of RBS b
p^{REP}: Battery replacement cost of RBS b (in $/W)
E_{b}^{CAP}: Battery capacity of RBS b
SoC_{b}^{max}: Battery maximum charge level of RBS b
SoC_{bt}^{max}: Battery max charge level of RBS b in time t
SoC_{bt}^{min}: Battery min charge level of RBS b in time t
SoC_{b}^{min}: Battery minimum charge level of RBS b
SoC_{bt}^{init}: Initial battery charge level of RBS b in time t
SoC_{b}^{init}: Initial battery charge level of RBS b
P_{bt}^{BS_CONS}: power consumption of RBS b during time t
Dist_{b,b′}: distance (in meters) between RBS b and b′
w₁ and w₂: weight values of the last two components of the optimization objective, respectively
p^{BID}: Agreed power bid
pₜ^{ELEC}=Energy price in regular market (in $/W) at hour t.
pₜ^{FCR}=FCR clearing price (in $/W) at hour t. Clearing price is the equilibrium monetary value of a traded security, asset, or good. This price may be determined by the ask-bid process of buyers and sellers, or more broadly, by the interaction of supply and demand forces, government regulations, etc.
pₜ^{PENAL}=Penalty price (in $/W) at hour t, for not being able to satisfy the FCR demand.
N(b)=neighborhood of RBS 16 b: each RBS 16 b′ belonging to it can serve as a backup RBS 16 in case RBS 16 b has a failure/fault. It is referred to as a standby RBS 16. In some embodiments, each N(b) is formed by the k nearest RBS 16 to b (k is also a parameter).
E_{bt}^{BS_CONS}=Energy consumption (in W) for operation of RBS 16 b during hour t.

### Variables

z_{γ}∈{0,1}: if configuration γ is selected, 0 otherwise.
x_{b}^{P}∈{0,1}: 1 if RBS 16 b is participating to the biding as a primary RBS 16, 0 otherwise.
x_{b}^{S}∈{0,1}: if RBS 16 b is participating to biding as a standby RBS 16, 0 otherwise.
x_{bt}^{P}∈{0,1}: 1 if RBS 16 b is participating to the biding as a primary RBS 16 during time period t, 0 otherwise.
x_{bt}^{S}∈{0,1}: 1 if RBS 16 b is participating to the biding as a standby RBS 16 during time period t, 0 otherwise.
yₜ∈{0,1}: 1 if t is the best time for bidding participation, 0 otherwise.
sₑ=1 if some RBS 16 is selected for bidding participation in electricity sector e, 0 otherwise.
sₐ∈{0,1}: 1 if some RBSs 16 are selected for biding participation in electricity area a, 0 otherwise [symbol]
δ^{DIAM}∈ [symbol] _{≥0}: cluster diameter

### Example 1—Optimization Model Example: One Bidding Hour and Maximum Profit

In some embodiments of the present disclosure, an optimization model for identifying the best bidding hour, assuming selection of a single day-ahead bidding hour (e.g., out of 24 bidding hours available), is used to determine the bidding hour which leads to the largest profit as follows:

$$max profit , \qquad ( Eq . 1 )$$

$$where$$

$$profit = {profit}^{FCR \_ UP} + {profit}^{FCR \_ DOWN} - {penalty}^{FCR} - {x}_{charge} - {bat}_{degrad} , \qquad ( Eq . 2 )$$

$$and$$

$${profit}^{FCR \_ UP} = {\sum }_{t ∈ T} {E}_{t}^{FCR \_ UP} {p}_{t}^{FCR} , \qquad ( Eq . 3 )$$

$${profit}^{FCR \_ DOWN} = {\sum }_{t ∈ T} {E}_{t}^{FCR \_ DOWN} {p}_{t}^{FCR} , \qquad ( Eq . 4 )$$

$${penalty}^{FCR} = {\sum }_{t ∈ T} {p}_{t}^{PENAL} ( {E}_{t}^{PENAL \_ UP} + {E}_{t}^{PENAL \_ DOWN} ) , \qquad ( Eq . 5 )$$

$${x}_{charge} = {\sum }_{t ∈ T} {E}_{t}^{X \_ CHARGE} {p}_{t}^{ELEC} , \qquad ( Eq . 6 )$$

$${bat}_{degrad} = {\sum }_{t ∈ T} {D}_{t} {p}^{REP} . \qquad ( Eq . 7 )$$

with

Overall FCR_UP and FCR_DOWN contribution per hour time are modeled by the following equations:

$${E}_{t}^{FCR \_ UP} = {\sum }_{b ∈ B} , t ∈ T \qquad ( Eq . 8 )$$

$${E}_{t}^{FCR \_ DOWN} = {\sum }_{b ∈ B} . t ∈ T \qquad ( Eq . 9 )$$

The penalty for not providing requested FCR demand is modeled by the following equation:

$${E}_{t}^{PENAL \_ UP} = {REQ}_{t}^{FCR \_ UP} - {E}_{t}^{FCR \_ UP} , t ∈ T \qquad ( Eq . 10 )$$

$${E}_{t}^{PENAL \_ DOWN} = {REQ}_{t}^{FCR \_ DOWN} - {E}_{t}^{FCR \_ DOWN} . t ∈ T \qquad ( Eq . 11 )$$

Recharging of the batteries 59 (to fully loaded level, using regular arbitrage energy service) is modeled according to the following equation:

$${E}_{t}^{CHARGE} = {\sum }_{b ∈ B} ( {SoC}_{b}^{max} - ) . t ∈ T \qquad ( Eq . 12 )$$

Total battery 59 degradation rate is modeled as:

$${D}_{t} = {\sum }_{b ∈ B} . t ∈ T \qquad ( Eq . 13 )$$

The Objective function may be rewritten as follows:

$$max profit = ( {\sum }_{b ∈ B} {\sum }_{t ∈ T} ) \qquad ( Eq . 14 )$$

$$- {\sum }_{t ∈ T} ( {REQ}_{t}^{{FCR}_{UP}} + {REQ}_{t}^{{FCR}_{DOWN}} ) {p}_{t}^{PENAL}$$

$$- {\sum }_{t ∈ T} {p}_{t}^{ELEC} ( {\sum }_{b ∈ B} {SoC}_{bt}^{max} )$$

where the last two terms are constant values (and therefore may be omitted in the optimization process), and where

$$= ( {E}_{bt}^{FCR \_ UP} + {E}_{bt}^{FCR \_ DOWN} ) ( {p}_{t}^{FCR} ) \qquad ( Eq . 15 )$$

$$- ( {E}_{bt}^{PENAL \_ UP} + {E}_{bt}^{PENAL \_ DOWN} ) ( {p}_{t}^{PENAL} )$$

$$- - {p}^{REP}$$

### Constraints:

Selection of participating RBSs 16 (primary and standby)

$$= {x}_{bt}^{P} b ∈ B , t ∈ T \qquad ( Eq . 16 )$$

$${x}_{b}^{P} = {\sum }_{t ∈ T} {x}_{bt}^{P} b ∈ B \qquad ( Eq . 17 )$$

$${x}_{b}^{S} = {\sum }_{t ∈ T} {x}_{bt}^{S} b ∈ B \qquad ( Eq . 18 )$$

Selection of the single bidding hour participation

$${x}_{bt}^{P} + {x}_{bt}^{S} \leq {y}_{t} b ∈ B , t ∈ T \qquad ( Eq . 19 )$$

$${\sum }_{t ∈ T} {y}_{t} = 1 \qquad ( Eq . 20 )$$

Guarantee at least one standby RBS 16 for each primary RBS 16 selected

$${x}_{bt}^{P} \leq {\sum }_{{b}^{′} ∈ N ( b )} {x}_{{b}^{′} t}^{S} b ∈ B , t ∈ T \qquad ( Eq . 21 )$$

Reduction in the energy grid consumption, to answer FCR down service is limited by the RBS 16 energy consumption. SoC limitation: see pricing discussion above.

$$\leq {E}_{bt}^{BS \_ CONS} b ∈ B , t ∈ T \qquad ( Eq . 22 )$$

Standby RBSs 16 must accommodate load of protected primary RBS 16 with their SoC.

Assumption: no more than one RBS 16 failure at any time.

$${\sum }_{{b}^{′} ∈ N ( b )} \geq {E}_{bt}^{BS \_ CONS} b ∈ B , t ∈ T \qquad ( Eq . 23 )$$

Selection of RBSs 16 in the same geographical area (e.g., based on a predefined diameter)

$${DIST}_{{bb}^{′}} ( {x}_{b}^{P} + {x}_{{b}^{′}}^{P} + {x}_{b}^{s} + {x}_{{b}^{′}}^{s} - 1 ) \leq diameter b , {b}^{′} ∈ B \qquad ( Eq . 24 )$$

Guarantee selection of RBSs 16 in the same electricity zone

$${\sum }_{b ∈ B} ( {x}_{b}^{P} + {x}_{b}^{S} ) \leq {Ms}_{e} e ∈ ES \qquad ( Eq . 25 )$$

$${\sum }_{e ∈ ES} {s}_{e} \leq 1 \qquad ( Eq . 26 )$$

### Domains of the Variables

$${x}_{b}^{P} , {x}_{b}^{S} ∈ \{ 0 , 1 \} b ∈ B \qquad ( Eq . 27 )$$

$${x}_{bt}^{P} , {x}_{bt}^{S} ∈ \{ 0 , 1 \} b ∈ B , t ∈ T \qquad ( Eq . 28 )$$

$${y}_{t} t ∈ T \qquad ( Eq . 29 )$$

$${s}_{e} ∈ \{ 0 , 1 \} e ∈ E \qquad ( Eq . 30 )$$

$$∈ \{ 0 , 1 \} ∈ Γ \qquad ( Eq . 31 )$$

Constraints (Eq. 16) decide on the selection of one RBS 16 battery configuration for a given RBS 16 and time period. If variable x_{bt}^{P}=1, then RBS 16 b participates in the bidding event during time period t, 0 otherwise.

Constraints (Eq. 17) take care of the consistency of the values of the variable x_{b}^{P} and x_{bt}^{P}, i.e., that variable x_{bt}^{P}=1 for at least one time slot if variable x_{b}^{P}=1. On the other hand, x_{b}^{P}=0 if variables x_{bt}^{P} are all equal to 0 for t∈T. Similarly, Constraints (Eq. 18) are written for ensuring consistency between variables x_{b}^{S} and x_{bt}^{S}.

Constraints (Eq. 19) and (Eq. 20) select the hour period of the participation: if variable yₜ=1, then base station b participates in the bidding event of time period t, either as a primary or a standby (but not both), 0 otherwise.

Constraints (Eq. 21) guarantee that at least one standby RBS 16 is selected for each primary RBS, in the close neighborhood of each primary RBS 16.

Constraints (Eq. 22) ensure that the reduction in the energy grid consumption (FCR down service) is limited by the RBS 16 energy.

Constraints (Eq. 23) guarantee that standby RBSs 16 have enough power load (SoC) to protect primary RBS 16 in case of single RBS 16 failure, i.e., that their overall SoC is larger than the required energy of the failed primary RBS 16.

Constraints (Eq. 24) ensure that the selected RBSs 16 are in the same geographical area. This is checked using the diameter, i.e., checking that the most apart RBSs 16 are within a given threshold (i.e., the input diameter value). Other Constraints could be added such as, e.g., within the same urban area.

Constraints (Eq. 25) and (Eq. 26) guarantee selection of RBSs 16 in the same electricity zone.

Constraints (Eq. 27) to (Eq. 31) account for the variable domains.

### Pricing Problem: Generation of Hourly FCR Pattern for a Given Participating RBS 16

The following problem/solution is described in terms of a given RBS 16 b and a given time period (hour) t, and thus the b and t indices are omitted below to streamline the notation. The pricing problem describes the set of FCR events in which the RBS 16 under study is participating, and for how much, during the time period under study.

Assumption: Since the model is for a single biding hourly period, it may be assumed that the time period is started with fully loaded batteries 59. In one or more embodiments, the model may be used for a multiple bidding hour period.

Output of the pricing problem associated with FCR configuration γ during time period t: SoCt and the battery degradation as measured by (Eq. 48).

The pricing problem allows the computation, for a given t, of the values of SoCt and of DoDₜ assuming the knowledge of all individual FCR events (in the order of seconds). It depends on the participation of the individual FCR events. Therefore, for a given t, different hourly FCR configurations are considered and then, with the solution of the master problem, the best (i.e., leading to most profit) configuration is selected. Each will vary with the participation of the RBS 16 battery 59 to each individual FCR event.

### Variables

yₑ=1 if the RBS 16 under investigation is participating in FCR event e, 0 otherwise.
a=1 if the battery 59 of the RBS 16 under consideration participates in the bidding, 0 otherwise.
SoCₑ=state of charge of the battery 59 of the RBS 16 under consideration at the end of event e.
Eₑ^{FCR_UP}=energy received by the grid and stored in the battery 59 (answering the FCR UP event e).
Eₑ^{FCR_DOWN}=energy provided by the battery to supply the RBS 16 (answering the FCR DOWN event e).
   Example: Consider a given RBS 16 with FCR set of events during time t: E={e₁, e₂, . . . , e₁₀}during time t→(output of the lower-level pricing) SoCt and DoDₜ at the end
of time t.
Configuration 1: τ₁→participation of the RBS 16 under investigation to FCR events e₁ and e₇.
Configuration 2: τ₂→participation of the RBS 16 under investigation to FCR events e₁, e₇ and e₉.

### Objective: Reduced Cost

Linear program: max cx subject to: Ax≤b, x≥0.

$${\sum }_{j ∈ J} {a}_{ij} {x}_{j} \leq {b}_{i} i ∈ I \qquad ( Eq . 32 )$$

Algebraic formula for the reduced cost (c): for a column j

$${\overline{c}}_{J} = {c}_{j} - {\sum }_{i ∈ I} {u}_{i} {a}_{ij} \qquad ( Eq . 33 )$$

Where i is the row index

$$= {bt}_{} - {u}_{bt}^{( 4 )} {a}_{bt} - {u}_{bt}^{( 10 )} - {u}_{bt}^{( 11 )} {\sum }_{{b}^{′} ∈ N ( b )} \qquad ( Eq . 34 )$$

where COST_{γ} is described in (Eq. 15). Omitting indices b and t becomes:

$$= - {u}^{( 4 )} a - {u}^{( 10 )} - {u}^{( 11 )} {\sum }_{{b}^{′} ∈ N ( b )} \qquad ( Eq . 35 )$$

### Constraints

BS participation means participation to at least one FCR event

$$a \geq {y}_{e} e ∈ E \qquad ( Eq . 36 )$$

SoC value after each event: if there is no participation, value is unchanged. Note that E values are null if no participation

$${SoC}_{e} = {SoC}_{PRED ( e )} + {E}_{e}^{FCR \_ UP} - {E}_{e}^{FCR \_ DOWN} e ∈ E \qquad ( Eq . 37 )$$

Participation of FCR UP events. Linear version required writing two sets of constraints.

$${E}_{e}^{FCR \_ UP} = {SoC}^{max} {y}_{e} e ∈ E \qquad ( Eq . 38 )$$

$${E}_{e}^{FCR \_ UP} = {SoC}^{max} - {SoC}_{PRED ( e )} e ∈ E \qquad ( Eq . 39 )$$

Participation in FCR DOWN events.

$${E}_{e}^{FCR \_ DOWN} = {My}_{e} e ∈ E \qquad ( Eq . 40 )$$

$${E}_{e}^{FCR \_ DOWN} = {SoC}_{PRED ( e )} - {SoC}^{min} e ∈ E \qquad ( Eq . 41 )$$

SoC must remain within valid boundaries

$${SoC}^{min} \leq {SoC}_{e} \leq {SoC}^{max} e ∈ E \qquad ( Eq . 42 )$$

### Domains of the Variables

$$a ∈ \{ 0 , 1 \} \qquad ( Eq . 43 )$$

$${y}_{e} ∈ \{ 0 , 1 \} e ∈ E \qquad ( Eq . 44 )$$

$${E}_{e}^{FCR \_ UP} , {E}_{e}^{FCR \_ DOWN} , {SoC}_{e} \geq 0 , e ∈ E \qquad ( Eq . 45 )$$

Using the solution of the pricing problem, the following values can be computed, which are coefficient values in the master problem for configuration γ (b, t):

$${E}_{t}^{FCR \_ UP} = {\sum }_{e ∈ {E}_{t}} {E}_{e}^{FCR \_ UP} {y}_{e} \qquad ( Eq . 46 )$$

$${E}_{t}^{FCR \_ DOWN} = {\sum }_{e ∈ {E}_{t}} {E}_{e}^{FCR \_ DOWN} {y}_{e} \qquad ( Eq . 47 )$$

$${D}_{t} = {\sum }_{e ∈ {E}_{t}} {D}_{e} {y}_{e} = {\sum }_{e ∈ {E}_{t}} \vert {E}_{e}^{FCR \_ DOWN} \vert {y}_{e} \qquad ( Eq . 48 )$$

where |Eₑ^{FCR_DOWN}|yₑ denotes the rounded value of Eₑ^{FCR_DOWN} that is the closest to the set of discrete battery discharge values.

### Example 2—Optimization Model: One Bidding Hour

Objective: maximize the profit (capacity and energy compensation profit) and minimize penalty, battery degradation cost, cluster range (diameter) and number of selected RBSs 16.

$$( Eq . 1 A )$$

$$maximize = {\sum }_{t ϵ T} {p}_{t}^{FCR} \cdot {p}^{BID} \cdot {y}_{t} + {\sum }_{t ϵ T} ( {E}_{t}^{FCR \_ UP} + {E}_{t}^{FCR \_ DOWN} ) \cdot {p}_{t}^{FCR} - {\sum }_{t ϵ T} ( {E}_{t}^{PENAL - UP} + {E}_{t}^{PENAL - DOWN} ) \cdot {p}_{t}^{PENAL} - {\sum }_{t ϵ T} {D}_{t} - {w}_{1} \cdot {δ}^{DIAM} - {w}_{2} \cdot {\sum }_{b ϵ B} ( {x}_{b}^{P} + {x}_{b}^{S} ) ,$$

with, for t E T, b E B:
Overall FCR-UP and FCR-DOWN contribution per hour time.

$${E}_{t}^{FCR ‐ UP} = {\sum }_{b ϵ B} {\sum }_{γ ∈ {Γ}_{bt}} {E}_{bt}^{FCR - UP , γ} \cdot {z}_{γ} ,$$

$${E}_{t}^{FCR ‐ DOWN} = {\sum }_{b ϵ B} {\sum }_{γ ∈ {Γ}_{bt}} {E}_{bt}^{FCR - DOWN , γ} \cdot {z}_{γ} ,$$

Penalty for not providing-requested FCR demand.

$${E}_{t}^{PENAL \_ UP} = {REQ}_{t}^{FCR \_ UP} \cdot {γ}_{t} - {E}_{t}^{FCR - UP} ,$$

$${E}_{t}^{PENAL \_ DOWN} = {REQ}_{t}^{FCR \_ DOWN} \cdot {y}_{t} - {E}_{t}^{FCR - DOWN} ,$$

Calculating the sum of all batteries' degradation cost.

$${D}_{t} = {\sum }_{b ϵ B} {\sum }_{γ ∈ {Γ}_{bt}} {D}_{bt}^{γ} \cdot {p}_{b}^{REP} \cdot {z}_{γ} .$$

Objective function can be rewritten as follows:

$$max = {\sum }_{t ϵ T} {\sum }_{b ϵ B} {\sum }_{γ ∈ {Γ}_{bt}} {COST}_{bt}^{γ} \cdot {z}_{γ} + {\sum }_{t ϵ T} {p}_{t}^{FCR} \cdot {p}^{BID} \cdot {y}_{t} - {\sum }_{t ϵ T} ( {REQ}_{t}^{FCR - UP} + {REQ}_{t}^{FCR - DOWN} ) \cdot {p}_{L}^{PENAL} \cdot {y}_{t} - {w}_{1} \cdot {δ}^{DIAM} - {\sum }_{b ϵ B}^{} {w}_{2} \cdot ( {x}_{b}^{P} + {x}_{b}^{s} ) , \qquad ( Eq . 2 A )$$

where the last three terms are constant values (and therefore can be omitted in the optimization process), and where:

### Constraints

$${COST}_{bt}^{γ} = ( {E}_{bt}^{FCR - UP , γ} + {E}_{bt}^{FCR - DOWN , γ} ) ( {p}_{t}^{FCR} + {p}_{t}^{PENAL} ) - {D}_{bt}^{γ} \cdot {p}_{b}^{REP} \qquad ( Eq . 3 A )$$

Selection of participating RBSs 16 (primary and standby):

$${\sum }_{γ ∈ {Γ}_{bt}} {z}_{γ} = {x}_{bt}^{P} , b ∈ B , t ∈ T , \qquad ( Eq . 4 A )$$

$${x}_{b}^{P} = {\sum }_{t ϵ T} {x}_{bt}^{P} , b ∈ B , \qquad ( Eq . 5 A )$$

$${x}_{b}^{S} = {\sum }_{t ϵ T} {x}_{bt}^{S} , b ∈ B , \qquad ( Eq . 6 A )$$

Selection of the single bidding hour participation:

$${x}_{bt}^{P} + {x}_{bt}^{S} \leq {y}_{t} , b ∈ B , t ∈ T , \qquad ( Eq . 7 A )$$

$${\sum }_{t ϵ T} {y}_{t} = 1. \qquad ( Eq . 8 A )$$

Guarantee that the entity does not provide more energy than what was requested in up or down regulation:

$${\sum }_{b ϵ B} {\sum }_{y ∈ {Γ}_{bt}} {E}_{bt}^{FCR - UP , γ} \cdot {z}_{γ} \leq {REQ}_{t}^{FCR - UP} , t ∈ T , \qquad ( Eq . 9 A )$$

$${\sum }_{b ϵ B} {\sum }_{y ∈ {Γ}_{bt}} {E}_{bt}^{FCR - DOWN , γ} \cdot {z}_{γ} \leq {REQ}_{t}^{FCR - DOWN} , t ∈ T . \qquad ( Eq . 10 A )$$

Ensure that the entity is capable of answering requests with the maximum agreed power bid (in MW) in both directions:

$${\sum }_{t ϵ T} {\sum }_{b ϵ B} {P}_{bt}^{BS \_ CONS} \cdot {x}_{bt}^{P} \geq {p}^{BID} , \qquad ( Eq . 11 A )$$

$${\sum }_{t ϵ T} {\sum }_{b ϵ B} {P}_{bt}^{ch} \cdot {x}_{bt}^{P} \geq {p}^{BID} . \qquad ( Eq . 12 A )$$

Guarantee that the entity as available energy in MWh) to be fully activate or, at least, 15 minutes in both directions:

$${\sum }_{t ϵ T} {\sum }_{b ϵ B} ( {SoC}_{bt}^{init} - {SoC}_{bt}^{min} ) {x}_{bt}^{P} \geq {p}^{BID} \cdot Δ h / 4 , \qquad ( Eq . 13 A )$$

$${\sum }_{t ϵ T} {\sum }_{b ϵ B} ( {SoC}_{bt}^{max} - {SoC}_{bt}^{init} ) {x}_{bt}^{P} \geq {p}^{BID} \cdot Δ h / 4. \qquad ( Eq . 14 A )$$

Guarantee at least one standby RBS 16 for each primary RBS 16:

$${x}_{bt}^{P} \leq {\sum }_{{b}^{′} ϵ N ( b )} {x}_{{b}^{′} t}^{s} b ∈ B , t ∈ T . \qquad ( Eq . 15 A )$$

Standby RBSs 16 must be prepared to accommodate, with their SoC, all FCR requests related to their primary RBSs 16:

$${\sum }_{γ ∈ {Γ}_{bt}} {E}_{bt}^{FCR - UP , γ} \cdot {z}_{γ} , \qquad ( Eq . 16 A )$$

$$\leq {\sum }_{{b}^{′} ϵ N ( b )} ( {SoC}_{{b}^{′} t}^{init} - {Soc}_{{b}^{′} t}^{min} ) {x}_{{b}^{′} t}^{s} , b ∈ B , t ∈ T ,$$

$${\sum }_{γ ∈ {Γ}_{bt}} {E}_{bt}^{FCR - DOWN , γ} \cdot {z}_{γ} , \qquad ( Eq . 17 A )$$

$$\leq {\sum }_{{b}^{′} ϵ N ( b )} ( {SoC}_{{b}^{′} t}^{max} - {Soc}_{{b}^{′} t}^{init} ) {x}_{{b}^{′} t}^{s} , b ∈ B , t ∈ T .$$

Selection of RBSs 16 in the same geographical area:

$${DIST}_{{bb}^{′}} ( {x}_{b}^{P} + {x}_{{b}^{′}}^{P} + {x}_{b}^{S} + {x}_{{b}^{′}}^{S} - 1 ) \leq {δ}^{DIAM} , b , {b}^{′} ∈ B . \qquad ( Eq . 18 A )$$

Selection of RBSs 16 in the same electricity area:

$${\sum }_{b ϵ {B}_{α}} ( {x}_{b}^{P} + {x}_{b}^{s} ) \leq M \cdot {s}_{α} , αϵ {A}^{ELEC} \qquad ( Eq . 19 A )$$

$${\sum }_{αϵ {A}^{ELEC}} {s}_{α} \leq 1. \qquad ( Eq . 20 A )$$

### Domains of the Variables:

$${x}_{b}^{P} , {x}_{b}^{s} ϵ \{ 0 , 1 \} , b ∈ B \qquad ( Eq . 21 A )$$

$${x}_{bt}^{P} , {x}_{bt}^{s} ϵ \{ 0 , 1 \} , b ∈ B , t ∈ T , \qquad ( Eq . 22 A )$$

$${y}_{t} ϵ \{ 0 , 1 \} t ∈ T , \qquad ( Eq . 23 A )$$

$${s}_{α} ϵ \{ 0 , 1 \} , α ϵ {A}^{ELEC} \qquad ( Eq . 24 A )$$

$${z}_{γ} ϵ \{ 0 , 1 \} , γ ∈ Γ \qquad ( Eq . 25 A )$$

$${δ}^{DIAM} ϵ {ℝ}_{\geq 0} \qquad ( Eq . 26 A )$$

Constraints (Eq. 4A) decides on the selection of one RBS 16 battery configuration for a given RBS 16 and time period. If variable X_{bt}^{P}=1, then RBS 16 b participates to the biding event during time period t, 0 otherwise.

Constraints (Eq. 5A) take care of the consistency of the values of variables X_{b}^{P} and X_{bt}^{P}, i.e., that variable X_{bt}^{P}=1 for at least one time slot if variable X_{b}^{P}=1. On the other hand, X_{b}^{P}=0 if variables X_{bt}^{P} are all equal to 0 for all t E T.

Similarly, constraints (Eq. 6A) are written for ensuring consistency between variables X_{b}^{s} and X_{bt}^{s}.

Constraints (Eq. 7A) and (Eq. 8A) select the hour period of the participation. If variable yₜ=1, then RBS 16 b participates to the biding event of time period t, either as a primary or a standby (but not both), 0 otherwise.

Constraints (Eq. 9A) and (Eq. 10A) guarantee that all selected RBSs 16 working as primary will not provide more energy than what was requested in up or down regulation.

Constraints (Eq. 11A) and (Eq. 12A) ensure that the entity (all selected primary RBSs 16) has a greater discharge power capacity than the bided value and also has a greater absorption power capacity than the bided value (respectively meeting the up and down regulation power requirement).

Constraints (Eq. 13A) and (Eq. 14A) guarantee that the entity (all selected primary RBSs 16) has enough energy to, respectively, discharge until reach bided value (up-regulation) and recharge until reach the bided value (down-regulation). However, units with limited energy reserves may be capable of being fully activated for at least 15 minutes in the bidding hour. Constraint (Eq. 15A) assures that at least one standby RBS 16 will be selected for each primary RBS 16.

Constraints (Eq. 16A) and (Eq. 17A) guarantee that the selected standby RBSs 16 have enough energy to deal with all FCR requests related to the primary RBS 16 (up and down requests). In other words, when b fails, b′ is prepared to contribute to the biding, replacing b.

Constraint (Eq. 18A), together with the objective function (see Eq. 1A), ensures that the cluster diameter SDIAM is minimized considering all distances DIST_{b,b′} among all selected RBSs 16 b and b′.

Constraints (Eq. 19A) and (Eq. 20A) guarantee that all selected primary and standby RBSs 16 belong to the same electricity zone. And finally, constraint (Eq. 21A) to (Eq. 26A) takes care of the domains of the variables

### Pricing Problem: Generation of Hourly FCR Pattern for a Given Participating RBS 16

It is written for a given RBS 16 b and a given time period (hour) t, so that b and t indices can be omitted to alleviate the notation. It describes the contribution of the RBS 16 under study, regarding the participation in a set of FCR requests (events) of t.

Let E be the set of FCR non-zero events, indexed by e. Set E is partitioned into E^{Down} and E^{Up} (for downwards and upwards regulation requests, respectively). Each FCR event is associated with a given requested amount of energy, Eₑ^{Req,up} or Eₑ^{Req,down}. Note that BS b may only contribute partially to what was requested in event e and may not participate in all events.

The pricing problem allows the computation of the contribution E_{bt}^{FCR-UP} and E_{bt}^{FCR-DOWN} and its related battery degradation D_{bt} for a given RBS 16 b and time t. As described in (Eq. 28A) and (Eq. 29A), contributions are defined and computed taking into account all events participation. The output of the pricing problem is associated with an FCR configuration r during time period t. Each new generated configuration is inserted in the master problem only if it is capable of improve the solution.

### Variables

SOCₑ=state of charge of the battery of the
   base station under consideration after
   FCR event e.
Eₑ^{FCR-UP}=reduction in energy grid
   consumption (obtained by supplying
   RBS 16 under investigation with its
   battery) for FCR event e.
Eₑ^{FCR-DOWN}=energy drained from the grid and
   stored in the battery of RBS 16 under
   investigation for FCR event e.
Dₜ=battery degradation rate associated
with the current time t (see subsection
V-B).
   Example: Consider a given RBS 16 b during time period t and a set of FCR events E={e₁, e₂, . . . , e₁₀}. At the end of time t, the output of the lower-level pricing can be represented by:

$$t {E}_{bt}^{FCR - UP} , {E}_{bt}^{FCR - DOWN} , {D}_{bt} .$$

### Objective: Reduced Cost

The reduced cost associated with each variable z_{y} can be written as:

$${RCOST}_{bt}^{γ} = {COST}_{bt}^{γ} - {u}^{( Eq . 4 A )} \qquad ( Eq . 27 A )$$

$$- {u}^{( Eq . 9 A )} {E}_{bt}^{FCR - UP} -$$

$${u}^{( Eq . 10 A )} {E}_{bt}^{FCR - DOWN}$$

$$- {u}^{( Eq . 16 A )} {E}_{bt}^{FCR - UP} - {u}^{( Eq . 178 A )} {E}_{bt}^{FCR - DOWN}$$

Where COST_{γ} is described in equation (7A) and u^{(Eq.4A)} [symbol] 0,u^{(Eq.9A)}≥0,u^{(Eq.10A)}≥0 u^{(Eq.16A)}≥0 and u^{(Eq.17A)}≥0 are dual values vectors of constraints (Eq. 4A), (Eq. 9A), (Eq. 10A), (Eq. 16A), (Eq. 17A), respectively

$${E}_{bt}^{FCR ‐ UP} = {\sum }_{e ϵ {E}_{t}} {E}_{e}^{FCR - UP} , \qquad ( Eq . 28 A )$$

$${E}_{bt}^{FCR - DOWN} = {\sum }_{e ϵ {E}_{t}} {E}_{e}^{FCR - DOWN} , \qquad ( Eq . 29 A )$$

After replacing COST_{bt}^{γ} by its expression (see (Eq. 3A)) and substituting the above expression (Eq. 28A) and (Eq. 29A) in (Eq. 27A) and in (Eq. 3A):

$${RCOST}_{bt}^{γ} = ( {\sum }_{e ϵ {E}_{t}} {E}_{e}^{FCR - UP} + {\sum }_{e ϵ {E}_{t}} {E}_{e}^{FCR - DOWN} ) ( {p}_{t}^{FCR} + {p}_{t}^{PENAL} ) \qquad ( Eq . 30 A )$$

$$- {p}^{REP} {D}_{t} - {u}^{( Eq . 4 A )} - ( {u}^{( Eq . 9 A )} + {u}^{( Eq . 10 A )} ) {\sum }_{e ϵ {E}_{t}} {E}_{e}^{FCR - UP}$$

$$- ( {u}^{( Eq . 16 A )} + {u}^{( Eq . 17 A )} ) {\sum }_{e ϵ {E}_{t}} {E}_{e}^{FCR - DOWN}$$

$$= {\sum }_{e ϵ {E}_{t}} ( {p}_{t}^{FCR} + {p}_{t}^{PENAL} - {u}^{( Eq . 9 A )} - {u}^{( Eq . 10 A )} ) {E}_{e}^{FCR - UP}$$

$$+ {\sum }_{e ϵ {E}_{t}} ( {p}_{t}^{FCR} + {p}_{t}^{PENAL} - {u}^{( Eq . 16 A )} - {u}^{( Eq . 17 A )} ) {E}_{e}^{FCR - DOWN}$$

$$- {u}^{( Eq . 4 A )} - {p}^{REP} {D}_{t} .$$

Constraints. Are written as follows.

A non-zero FCR event is associated with either upwards or downwards regulation. Thus, the set E can be represented by:

$$E = {E}^{UP} ⋃ {E}^{DOWN} , {E}^{UP} ⋂ {E}^{DOWN} = ∅ .$$

In addition, assume SoCₑ_{₀}=SoC^{init}, where e₀ is an artificial event that contains the initial state of charge of the battery of RBS 16 b. Also, SOC_{pred(e)} denotes the SoC values at the end of the previous FCR event.

Updating of SoC value:

$$\begin{matrix}{SoC}_{e} = {SoC}_{pred ( e )} + {E}_{e}^{FCR - DOWN} , & e ϵ {E}^{DOWN}\end{matrix} ⋃ \{ {e}_{0} \} , \qquad ( Eq . 31 A )$$

$$\begin{matrix}{SoC}_{e} = {SoC}_{pred ( e )} - {E}_{e}^{FCR - UP} , & e ϵ {E}^{UP}\end{matrix} ⋃ \{ {e}_{0} \} . \qquad ( Eq . 32 A )$$

### Participation of FCR Down Events:

$$\begin{matrix}{E}_{e}^{FCR - DOWN} \leq {SoC}^{max} - {SoC}_{pred ( e )} , & e ϵ {E}^{DOWN}\end{matrix} ⋃ \{ {e}_{0} \} . \qquad ( Eq . 33 A )$$

### Participation to FR Up Events:

$$\begin{matrix}{E}_{e}^{FCR - UP} \leq {E}^{BS \_ CONS} , & e ϵ {E}^{UP} ,\end{matrix} \qquad ( Eq . 34 A )$$

$$\begin{matrix}{E}_{e}^{FCR - UP} \leq {SoC}_{pred ( e )} - {SoC}^{min} , & e ϵ {E}^{UP} ⋃ \{ {e}_{0} \} .\end{matrix} \qquad ( Eq . 35 A )$$

Soc Must Remain within Some Boundaries:

$$\begin{matrix}{SoC}^{min} \leq {SoC}_{e} \leq {SoC}^{max} , & e ϵ E ,\end{matrix} \qquad ( Eq . 36 A )$$

### Bond Contributions to What is Requested:

$$\begin{matrix}0 \leq {E}_{e}^{FCR - UP} \leq {E}_{e}^{REQ , UP} , & e ϵ {E}^{UP} ,\end{matrix} \qquad ( Eq . 37 A )$$

$$\begin{matrix}0 \leq {E}_{e}^{FCR - DOWN} \leq {E}_{e}^{REQ , DOWN} , & e ϵ {E}^{DOWN} .\end{matrix} \qquad ( Eq . 38 A )$$

Constraints (Eq. 31A) and (Eq. 32A) take care of the SoC value update after each FCR participation. Note that an artificial event e₀, representing the initial SoC, was included in the set. Thus, after each FCR participation, denoted by Eₑ^{FCR-DOWN} and Eₑ^{FCR-UP} the SoC value at the end of the current event is updated. If no participation, SoC value remains unchanged.

Constraint (Eq. 33A) deal with the down regulation requests, which means decreasing energy production or increasing consumption (in our case, done through battery charging). As batteries have limited storage capacity, (Eq. 33A) ensures that the battery does not receive more energy than their remaining capacity, i.e., SoC^{max}-SOCₑ.

On the other hand, constraints (Eq. 34A) and (Eq. 35A) deal with the up-regulation requests, which means increasing energy production or decreasing consumption. In one or more embodiments, in order to reduce the energy consumption, RBS 16 b is supplied, partially or fully, with its battery. More specifically, constraint (Eq. 34A) assures that the reduction in energy consumption is lesser or equal to the current energy consumption of the RBS 16 under analysis.

Constraint (Eq. 35A) ensures that the battery does not discharge further than SoC^{min} value.

Constraint (Eq. 36A) guarantees that the SoC remains in its allowed boundaries. And finally, constraints (Eq. 37A) and (Eq. 38A) ensure that no more energy than what was requested will be provided.

It is worth noting that, to simplify the model, charging/discharging losses (regarding battery efficiency) are not considered.

### Computing the Battery Degradation:

Also using the solution of the pricing problem, the battery degradation Dₜ can be estimated considering the degradation caused by each event as follows:

$${D}_{t} = {\sum }_{e ∈ {E}_{t}} {D}_{e} {y}_{e} \qquad ( Eq . 49 )$$

The calculation of the battery degradation may be performed based on the degradation curve (e.g., Max Cycles vs DoD). As this curve is non-linear, it may need to be linearized using some method (e.g., piece-wise approximation) in order to be able to introduce it in our model. Then, after the linearization method, the curve is divided into d linear sections. Assuming that the battery End of Life (EoL) occurs when their nominal capacity is decreased by 20%, the degradation rate for each DoD value can be determined as follows:

$$D = \frac{0.2}{{N}^{max \_ cycles}} , \qquad ( Eq . 50 )$$

Where D is the degradation rate (in p.u./cycle) and N^{max_cycles} is the maximum number of cycles at each specific DoD. Then, each segment of the degradation rate can be described as follows:

$${D}_{d} = {D}_{d}^{M} {DoD}_{e , d} + {D}_{d}^{B} , \qquad ( Eq . 51 )$$

where D_{d} is the degradation rate value (p.u./cycle) for a specific DoD in the segment d, DoD_{e,d} is the DoD in segment d at time event e, D_{d}^{M} is the slope of segment d, and D_{d}^{B} is the y-intercept point of segment d. The following equation limits DoD to a specific segment:

$${DoD}_{d}^{min} \leq {DoD}_{e , d} \leq {DoD}_{d}^{max} , \qquad ( Eq . 52 )$$

where parameters DoD_{d}^{min} and DoD_{d}^{max} are the minimum and maximum values of DoD of each segment d, respectively. In order to introduce the degradation rate for each event in the model, the following restrictions are necessary:

$${\sum }_{e ϵ {E}_{t}^{DOWN}} \frac{{E}_{e}^{FCR \_ DOWN}}{{E}^{CAP}} = {\sum }_{d ∈ D} {DoD}_{e , d} , \qquad ( Eq . 53 )$$

$${DoD}_{t , d} \geq {DoD}_{d}^{min} {S}_{e , d}^{DoD} , \qquad ( Eq . 54 )$$

$${DoD}_{t , d} \leq {DoD}_{d}^{max} {S}_{e , d}^{DoD} , \qquad ( Eq . 55 )$$

$${\sum }_{d ∈ D} {S}_{e , d}^{DoD} \leq 1 , \qquad ( Eq . 56 )$$

$${D}_{e} = {\sum }_{d ∈ D} {D}_{d}^{M} {DoD}_{e , d} + {D}_{d}^{B} {S}_{e , d}^{DoD} , \qquad ( Eq . 57 )$$

where S_{e,d}^{DoD} is a binary variable indicating the segment to which the battery discharge corresponds, E^{CAP} indicates the battery total capacity and Dₑ is the degradation rate at event e. Equation (Eq. 53) regards the relationship between the energy discharge and DoD. Equations (Eq. 54)-(Eq. 56) assign the total DoD obtained with (Eq. 40), to a specific segment of the curve. Equation (57) determines the degradation rate at event e.

The battery maintenance policy may thus affect the overall profit.

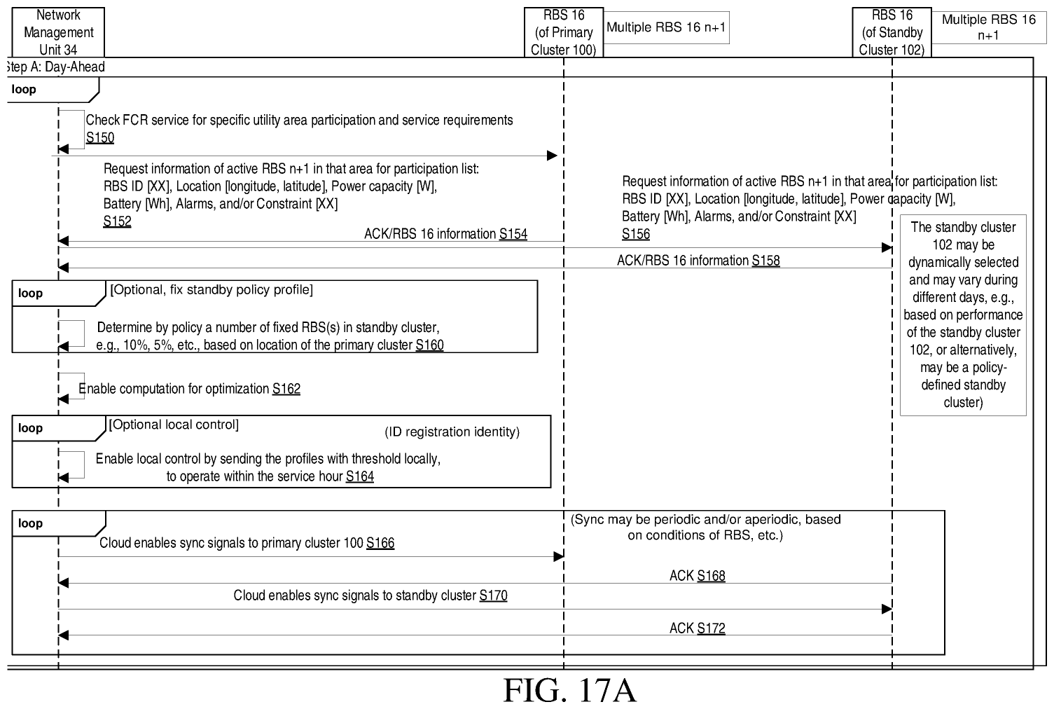

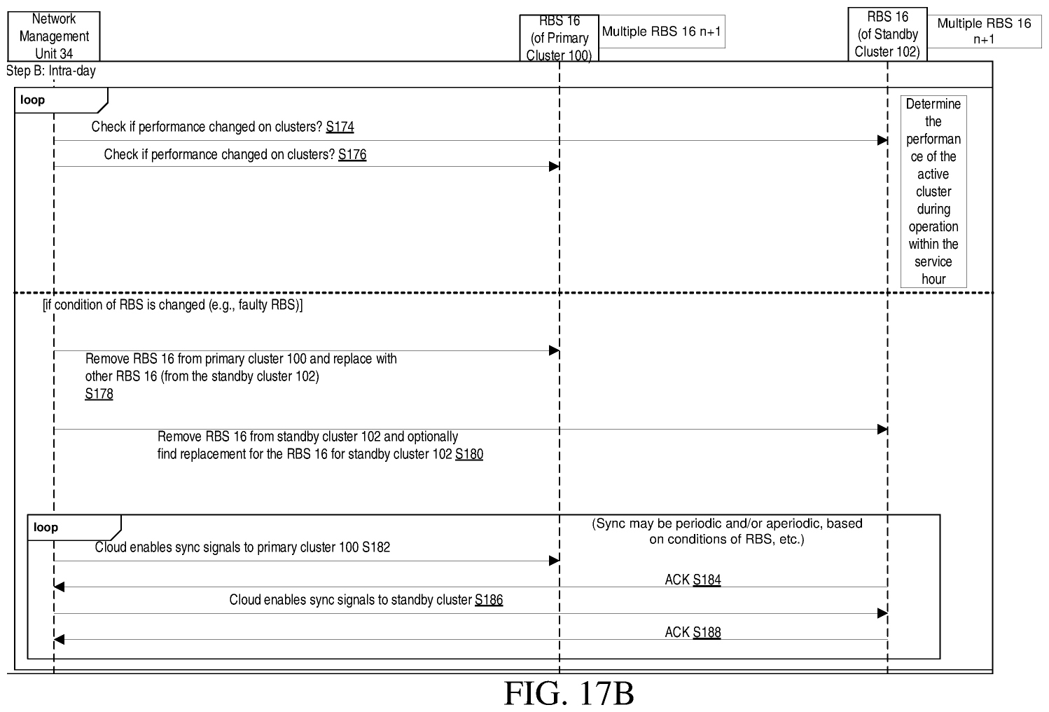

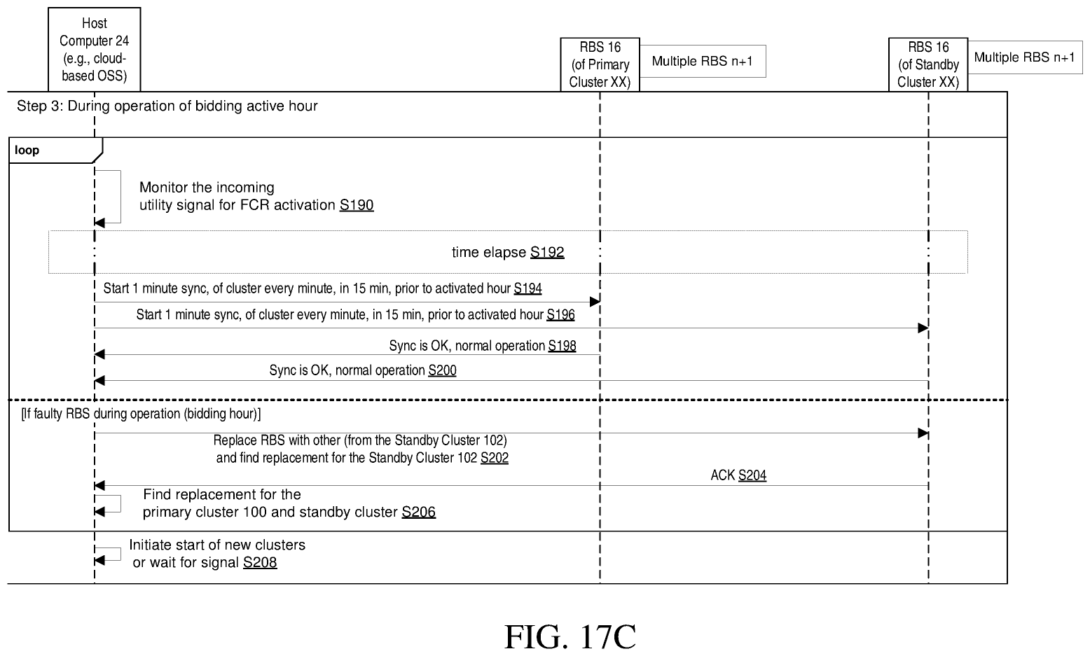

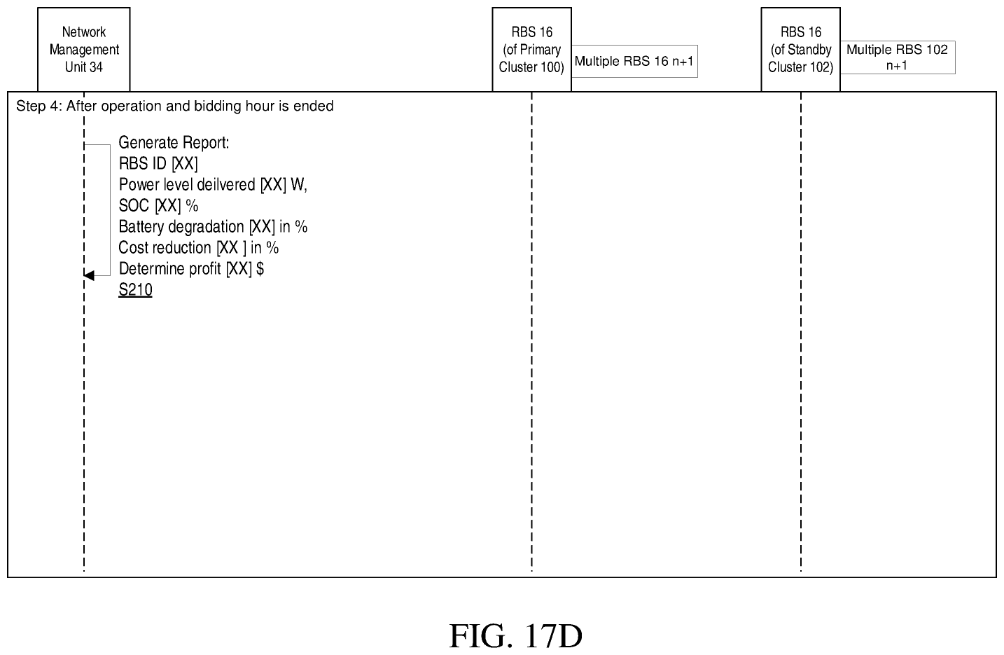

FIGS. 17A-D depict an example sequence diagram of day-ahead (FIG. 17A), intra-day (FIG. 17B), during operation sync and orchestration of faulty RBS 16 (FIG. 17C), and report generation after operation and bidding hour is ended (FIG. 17D).

FIG. 17A (Step A: Day-Ahead) depicts an example day-ahead procedure during which the network management unit 34 checks FCR services available for participation/bidding in a given electric area/grid/region/etc. It should be noted that although the term “day-ahead” is used in this example, a “day-ahead” is merely used as an example time period, which may vary, e.g., based on the particular electric grid and/or utility operator's configuration. For example, a utility operator may solicit FCR bids any time period prior to the bidding hour (e.g., a day ahead, two days ahead, two hours ahead, a year ahead, etc.). In other words, the “day-ahead” period as used herein refers to the period during which the utility solicit bids, which may or may not be literally a day before the FCR period which is the subject of the bidding. Note that these steps are described as being performed by network management unit 34, but it is to be understood that in some embodiments, one or more of these steps may also/alternatively be performed by one or more other units/entities of management node 24, RBS 16, core node 14, etc., without deviating from the scope of the present disclosure.

In Step A.1, the network management unit 34 collects information of all RBS 16 available in a particular area/grid/region/etc. Specifically, in Step S150, the Network management unit checks FCR service for a specific utility area to determine participation and service requirements. In Step S152, the network management unit 34 requests information from one or more active RBS 16 (e.g., from one or more of RBS n+1 in the primary cluster 100 in the utility area) to determine a participating RBS 16 list or similar data structure, which may include, for example, RBS ID, Location [longitude, latitude], Power capacity [W], Battery [Wh], Alarms, constraints, capabilities, etc., which may be reported, e.g., by status reporting unit 32 of one or more of RBS 16 of primary cluster 100, in Step S154, along with an acknowledgment. In Step S156, the network management unit 34 requests information from one or more RBS 16 of standby cluster 102, similar to the information requested in Step S152, one or more of the RBS 16 respond accordingly, similar to the response of Step S158. The network management unit 34 now has information corresponding to the identities and status/condition of the pluralities of RBS 16 in each of the primary cluster 100 and standby cluster 102.

If a primary cluster 100 and/or standby cluster 102 has not previously been determined, network management unit 34 may be preconfigured with a list or similar data structure identifying candidate RBS 16 in the utility area for assigning to a new primary cluster 100 and/or standby cluster 102. In some embodiments, the standby cluster 102 may be dynamically selected and may vary during different days, e.g., based on performance of the standby cluster 102, or alternatively, may be a policy-defined standby cluster. For example, in Step S160, which may be an optional step, a standby policy profile is determined, e.g., determine by policy a number of fixed RBS(s) in standby cluster 102, e.g., 10%, 5%, etc., based on location of the primary cluster 100.

In Step A.2, the network management unit 34 runs an optimization model for data predictions (as described herein) and uses the optimization model to find the best time slot(s) to participate in/bid for, to determine which RBS 16 to assign to one or more primary clusters 100, which RBS 16 to assign to one or more standby clusters 102, to determine which profiles to assign to which RBS 16/clusters, etc. Specifically, in Step S162, the network management unit 34 performs optimization computations, as described herein, for assigning one or more RBS 16 to the various clusters, and/or for determining profile(s) to assign to the RBS 16 for local implementation of AS/FCR. In Step S164, which may be an optional step, the network management unit 34 causes the profiles to be sent to one or more RBS 16 of the primary cluster 100 and/or standby cluster 102, thereby enabling local control and reducing the latency associated with control signaling from the network management unit 34/management node 24 to each of the RBS 16. For example, the profile may specify/indicate one or more threshold values (e.g., maximum battery 59 charge, minimum battery 59 charge, etc.), timing values, performance parameters, etc., which the RBS 16 (e.g., power management unit 33) use to control power consumption, e.g., by supplying power to/from one or more elements of hardware 58, in response to signals received from network management unit 34, power grid 95, utility operator signaling 99, other RBS 16 (e.g., other RBS 16 of primary cluster 100 which relay an activation signal), etc.

In Step A.3, the network management unit 34 performs synchronization of the primary cluster 100 and the standby cluster 102, which may be either periodic and/or aperiodic (e.g., based on conditions), such as by causing profiles to be transmitted to one or more of the RBS 16 in each cluster, the profiles being configured to cause the RBS 16 in each cluster to implement the provisioned AS/FCR services, as described herein. Specifically, in Step S166, the network management unit 34 causes synchronization signaling, such as profiles, to be sent to one or more RBS 16 of primary cluster 100. In Step S168, the one or more RBS 16 of the primary cluster 100 respond with an acknowledgment and/or with status information (e.g., as reported by status reporting unit 32). Similarly, in Step S170, profiles are sent to one or more RBS 16 of the standby cluster 102, which respond similarly to the response of Step S170.

FIG. 17B (Step B, Intra-Day) depicts an example intra-day procedure. In Step B.1, the network management unit 34 checks the status of the RBS 16 of the primary cluster 100 and/or the standby cluster 102. Specifically, in Step S174, the network management unit 34 checks if the performance/conditions/battery 59 state/etc. (e.g., as monitored by one or more status reporting units 32 of one or more corresponding RBS 16) has changed on the primary cluster 100 and/or standby cluster 102, for example, by requesting and receiving status reports from RBS 16/status reporting units 32 indicating the state/condition/etc. of the hardware 58 of one or more RBS 16 in each cluster, indicating which, if any, RBS 16 is experiencing a fault/error condition, indicating traffic conditions (e.g., actual or predicted, based on control information indicating traffic demands received from one or more wireless devices 22 served by the corresponding RBS 16), etc. Similarly, in Step S176, the network management unit 34 requests and receives status information from one or more RBS 16 of standby cluster 102. If the status of any of the RBS 16 of the primary cluster 100 has changed (i.e., such that the RBS 16 no longer satisfies one or more requirements for participating in AS/FCR service), the network management unit 34 replaces at least one RBS 16 from the primary cluster 100 with at least one other RBS 16 from the standby cluster 102 in Steps S178 and S180. Optionally, the network management unit 34 finds at least one replacement RBS 16 to recomplete/repopulate the standby cluster 102, as described herein.

In Step B.2, the network management unit 34 synchronizes the primary cluster 100 and/or the standby cluster 102, which may be periodic and/or aperiodic (e.g., based on conditions). Specifically, in Step S182, the network management unit 34 causes synchronization signaling, such as profiles, to be sent to one or more RBS 16 of primary cluster 100. In Step S184, the one or more RBS 16 of the primary cluster 100 respond with an acknowledgment and/or with status information (e.g., as reported by status reporting unit 32). Similarly, in Step S186, profiles are sent to one or more RBS 16 of the standby cluster 102, which respond similarly to the response of Step S188.

FIG. 17C, Step C, depicts an example active hour (bidded hour) operation. In Step C.1, the network management unit 34 monitors the incoming FCR activation signal received, e.g., from the electric utility. As previously noted herein, the “active hour” or “bidding hour” may be any length of time (e.g., an hour, 30 minutes, 30 seconds, etc.), which is defined/determined based on the electric grid's bidding procedure, for instance. Specifically, in Step S190, the network management unit 34 monitors AS/FCR service for a specific utility area, such as receiving a set of indicators from utility operator (e.g., via utility operator signaling 99) corresponding to participation and service requirements, and/or monitoring for an activation signal, and/or monitoring for a change in conditions in the power grid 95 which trigger AS/FCR service. An arbitrary amount of time elapses in Step S192. In Steps S194 and S196, network management unit 34 starts a 1 minute synchronization of the RBS 16 of primary cluster 100 and of the secondary cluster 102, respectively, every minute, in 15 minutes increments, prior to the active hour (note that these are merely example times, and the specific time interval/period lengths may vary based on electric utility preferences/requirements, MNO preferences/requirements, optimization procedures, etc.). The synchronization process may include, for example, causing profiles to be transmitted to the one or more RBS 16 in the clusters prior to bidding hour, and during the active/service/running hour. Synchronization may be used for running tests/simulations during or before the active/service/running hour, for example, performing a test activation to determine whether the RBS 16 of the primary cluster 100 are able to meet timing, latency, and/or power modification requirements. In Steps 198 and S200, the RBS 16 of the primary cluster 100 and standby cluster 102, respectively, indicate to the network management unit 34 that synchronization is complete (i.e., that the RBS 16 are operating according to requirements, that the profiles have been successfully received and implemented, that the test(s) ran without faults/errors, etc.).

In Step C.2, the network management unit 34 performs a normal synchronization (e.g., causing profiles to be transmitted to the RBS 16 in the appropriate clusters with updated instructions on implementing AS/FCR services). In Step C.3, the network management unit 34 checks for alarms and, if a fault occurs, enables the next RBS 16 from the standby cluster 102 to participate. Specifically, Steps S202, S204, and S206 describe a similar process of replacing RBS 16 of the primary cluster 100 with RBS 16 of the secondary cluster 102, as described above with respect to Steps S178 and S180. In Step S208, the network management unit 34 either initiates a start of new clusters, and/or waits for an activation signal for AS/FCR service.

FIG. 17D depicts an example reporting procedure (Step S210) which occurs, for instance, after the conclusion of the active hour, the network management unit 34 generates a report which may include, for example, RBS ID, Power level delivered to the power grid 95 (in Watts), SoC (e.g., as a % of total charge capacity), battery 59 degradation (e.g., in % of initial charge capacity), cost/cost reduction (e.g., in %), and a determined profit (e.g., in dollars/euros/etc.).

Synchronization of Clusters Based on Performance from Network Management Unit 34

After finding the best clusters (e.g., the selection of RBS 16 which results in the most profit while minimizing disruption to quality of service provided to wireless devices 22 and/or minimizing degradation to batteries 59) for participating in each next day biding hours (e.g., as depicted in FIG. 14), the network management unit 34 enables, during the intra-day, synchronization signals (periodic or aperiodic)/determining profiles and causing the profiles to be transmitted to the RBS 16, to align the plurality of RBS 16 of each cluster with one another and continually check their conditions (e.g., as reported by status reporting units 32). Note that this synchronization signaling, which may be sent via connection 66, is not necessarily the same signal as the activation signaling received from utility operator (e.g., via utility operator signaling 99), although management node 24 may cause the activation signaling to be forwarded/relayed to one or more RBS 16 via the same connection 66 as the synchronization signaling.

In some embodiments, the synchronization signaling (e.g., sent via connection 66) may contain information/operation settings, such as 1) ON/OFF signaling, 2) site profiles (e.g., operation settings), 3) battery profiles, 4) PSU 67 profiles, 5) power profiles, 6) load profiles, 7) MW/Hz profiles, 8) cluster profiles, and/or 9) radio profiles.

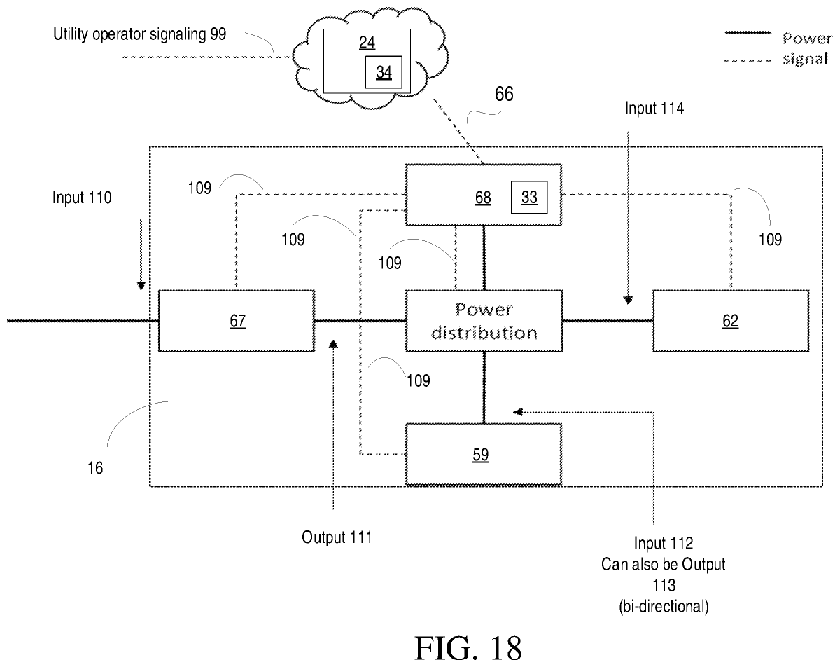

The profiles may contain threshold values, patterns, of activation signal to initiate an RBS 16 or a sequence of RBS 16 in the service participation, as depicted in the example of FIG. 16, where the different profiles are used by power management unit 33 to control the different input and outputs of one or more of the RBS 16. For example, FIG. 18 depicts various control signals 109 that are used to control and synchronize components of each RBS 16, based on profiles received from network management unit 34 (e.g., via connection 66) and an activation signal (e.g., utility operator signaling 99) received from the utility operator (e.g., received indirectly via the network management unit 34 via connection 66). Different profiles may respond to control signals differently, producing different technical effects in operation. PSU 67 input 110 may be controlled (e.g., based on the utility operator signaling 99 indicating an FCR activation request) so as to stabilize the input power and set (e.g., different thresholds) for the PSU 67 input current to different input power levels, e.g., based on demand. In some embodiments, the profiles for the RBS 16 of a primary cluster 100 are configured so that the PSU 67 inputs within the same cluster have the same or similar values, producing similar/stable behaviors for the RBS 16 across the cluster. The RBS 16 may be required (e.g., by utility operator specifications) to deliver stable power, in response to each FCR request, in order to avoid penalties.

PSU 67 output 111 can be controlled (by power management unit 33) so that PSU voltage output adjustment can be made to lower the output voltage and keep the input power constant during the synchronization signal or when local control is applied or to reduce the PSU 67 input power to a specified power level, based on demand. In this way some of the power is delivered from the battery 59.

Battery 59 input 112 may be controlled (e.g., by power management unit 33) so as to avoid charging during active bidding hour. The charging may be done later, at night to avoid excessive peak power, or within the FCR active hour (e.g., when a utility operator signaling 99 including an activation signal is received indicating an FCR-Down Regulation period where the power consumption of one or more RBS 16 of the primary cluster 100 should increase).

Battery 59 output 113 may be active to support with power both during the FCR request signal (within same bidding/service hour) and support with power to radio, including the radio power variation.

Radio input power 114 will depend largely on the radio traffic variation, related to the number of wireless devices 22 connected, the traffic needs thereof, time of day, interference/noise levels, signaling efficiency, etc. The radio input power 114 to the radio may fluctuate during operation. In some embodiments, the power management unit 33 may handle this variation of fluctuation inside the power architecture (e.g., by increasing/decreasing power from battery 59 as appropriate).

Furthermore, the control profiles may be sent in advance, may be changed during operation, and be activated locally during service hours. For example, each power management unit 33 of one or more RBS 16 of the primary cluster 100 may respond to an activation signal received from network management unit 34 and/or utility operator signaling 99 by increasing power supplied to/from the battery (via control signals 109), as described herein, thereby reducing latency as compared to an embodiment where the network management unit 34 must send one or more of control signals 109. Furthermore, profiles may be stored locally or changed from centralized location at any time. In some embodiments of the present disclosure, the profiles may be changed or adapted on intra-day based on new information related to re-running the method.

In some embodiments of the present disclosure, the synchronization signal received via connection 66 may also contain information relayed from the utility operator signaling 99 and/or may include control information which is associated with and/or determined based on the utility operator signaling 99. Policies may be set (e.g., via the profiles signaled to the RBS 16), to avoid charging of battery 59 during the FCR bidding hour, which may affect the operation of the PSU 67, during non-requested signals during the service hour.

In some embodiments, the network management unit is configured to report values back to the TSO/DSO, such as power levels of one or more RBS 16, SoC of one or more batteries 59, etc.

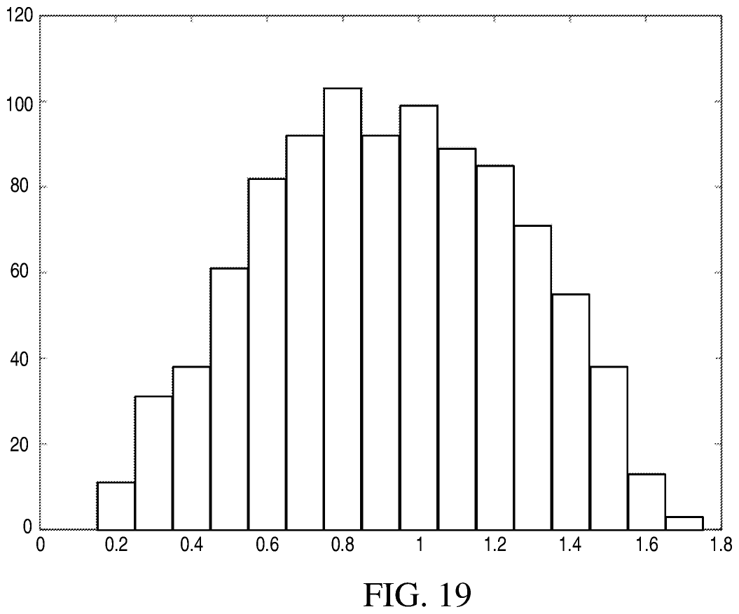

FIG. 19 is a histogram depicted an example simulated PSU 67 output control according to embodiments of the present disclosure. The histogram depicts a distribution of latency timing of the PSU 67 control signaling 109, with the X-axis representing latency in seconds and the Y-axis representing the number of tests. For example, PSU 67 latency of 1 second is within the limits of practical operation for many FCR services. As another example, roundtrip latency related to utility operator signaling 99 was calculated/simulated to be 2 seconds. In total, the simulation example produced a total latency of between 3.5-4 seconds to enable the control signal (e.g., utility operator signaling 99 activating FCR service), with existing power infrastructure equipment. This is within the limits/requirements of the services as described in the example of Table 1, above.

### Some Examples

Example A1. An RBS 16 supplied with power from a power grid and configured to communicate with a network management unit 34 (e.g., management node 24), the RBS 16 configured to, and/or comprising a radio interface 62 and/or comprising processing circuitry 68 configured to:
receive a synchronization signal from the network management unit 34, the synchronization signal indicating a schedule including an activation period;
during the activation period, receive an activation signal from the network management unit 34; and
in response to the activation signal, modify the power consumption of the RBS 16 based on the synchronization signal and the activation signal.

Example A2. The RBS 16 of Example A1, wherein the synchronization signal indicates an ancillary services, AS, profile, for controlling power consumption of the RBS 16.

Example A3. The RBS 16 of Example A2, wherein the AS profile indicates one of a primary cluster and a standby cluster to which the RBS 16 is assigned, the AS profile being shared by at least one other RBS 16 of the cluster to which the RBS 16 is assigned.

Example A4. The RBS 16 of Example A3, wherein the AS profile indicates a standby cluster to which the RBS is assigned, the RBS 16 being further configured to receive an updated synchronization signal from the network management unit 34 indicating an updated AS profile, the updated AS profile indicating a reassignment to a primary cluster, the reassignment being associated with at least one fault condition of another RBS 16 assigned to the primary cluster.

Example A5. The RBS 16 of any of Examples A1-A4, wherein the RBS 16 is further configured to:
determine a status report indicating a condition of the RBS 16; and
cause transmission of the status report to the network management unit 34, the synchronization signal being determined based on the status report.

Example A6. The RBS 16 of any of Examples A1-A5, wherein the activation signal indicates a Frequency Containment Reserve, FCR, Down Regulation event, the modifying of the power consumption by the RBS 16 including reducing the power supplied from the power grid to the RBS 16.

Example A7. The RBS 16 of Example A6, wherein the RBS 16 includes a battery 59 the reducing of the power supplied from the power grid including switching from the power supplied by the power grid to power supplied by the battery 59.

Example A8. The RBS 16 of Example A7, wherein the synchronization signal indicates a first threshold and a second threshold lower than the first threshold, the schedule including a first period prior to the activation period, the RBS 16 being further configured to:
maintain the battery charge above the first threshold during the first period; and
decrease the battery charge to the second threshold during the activation period based on the activation signal indicating an FCR-Down Regulation event.

Example A9. The RBS 16 of any of Examples A1-A8, wherein the activation signal indicates an FCR-Up Regulation event, the modifying of the power consumption by the RBS 16 including increasing the power supplied by the power grid to the RBS 16.

Example A10. The RBS 16 of any Example A9, wherein the RBS 16 includes a battery, the increasing of the power supplied from the power grid including charging the battery 59.

Example A11. The RBS 16 of Example A10, wherein the synchronization signal indicates a first threshold and a second threshold higher than the first threshold, the schedule including a first period prior to the activation period, the RBS 16 being further configured to:
maintain the battery charge below the first threshold during the first period; and
increase the battery charge to the second threshold during the activation period based on the activation signal indicating an FCR-Up Regulation event.

Example A12. The RBS of any of Examples A3-A11, wherein the synchronization signal, including the AS profile, is received by the RBS 16 prior to the active hour, the processing circuitry 68 being further configured to:
execute the AS profile within the active hour, the AS profile optionally including a profile control, the profile control indicating at least one of:
   synchronization of the RBS in response to every demand from the network management unit 34 to execute the AS profile; and
   local execution on at least one local controller; and
   execute at least one power modification process based on at least one threshold indicated by the AS profile.

Example B1. A method implemented in an RBS 16 supplied with power from a power grid and configured to communicate with a network management unit 34 (e.g., management node 24), the method comprising:
receiving a synchronization signal from the network management unit 34, the synchronization signal indicating a schedule including an activation period;
during the activation period, receiving an activation signal from the network management unit 34; and
in response to the activation signal, modifying the power consumption of the RBS 16 based on the synchronization signal and the activation signal.

Example B2. The method of Example B1, wherein the synchronization signal indicates an ancillary services, AS, profile, for controlling power consumption of the RBS 16.

Example B3. The method of Example B2, wherein the AS profile indicates one of a primary cluster and a standby cluster to which the RBS 16 is assigned, the AS profile being shared by at least one other RBS 16 of the cluster to which the RBS 16 is assigned.

Example B4. The method of Example B3, wherein the AS profile indicates a standby cluster to which the RBS 16 is assigned, the method further comprising receiving an updated synchronization signal from the network management unit 34 indicating an updated AS profile, the updated AS profile indicating a reassignment to a primary cluster, the reassignment being associated with at least one fault condition of another RBS 16 assigned to the primary cluster.

Example B5. The method of any of Examples B1-B4, further comprising:
determining a status report indicating a condition of the RBS 16; and
causing transmission of the status report to the network management unit 34, the synchronization signal being determined based on the status report.

Example B6. The method of any of Examples B1-B5, wherein the activation signal indicates a Frequency Containment Reserve, FCR, Down Regulation event, the modifying of the power consumption by the RBS 16 including reducing the power supplied from the power grid to the RBS 16.

Example B7. The method of Example B6, wherein the RBS 16 includes a battery 59, the reducing of the power supplied from the power grid including switching from the power supplied by the power grid to power supplied by the battery 59.

Example B8. The method of Example B7, wherein the synchronization signal indicates a first threshold and a second threshold lower than the first threshold, the schedule including a first period prior to the activation period, the method further comprising:
maintaining the battery charge above the first threshold during the first period; and
decreasing the battery charge to the second threshold during the activation period based on the activation signal indicating an FCR-Down Regulation event.

Example B9. The method of any of Examples B1-B8, wherein the activation signal indicates an FCR-Up Regulation event, the modifying of the power consumption by the RBS 16 including increasing the power supplied by the power grid to the first RBS 16.

Example B10. The method of any Example B9, wherein the RBS 16 includes a battery 59, the increasing of the power supplied from the power grid including charging the battery 59.

Example B11. The method of Example B10, wherein the synchronization signal indicates a first threshold and a second threshold higher than the first threshold, the schedule including a first period prior to the activation period, the method further comprising:
maintaining the battery charge below the first threshold during the first period; and
increasing the battery charge to the second threshold during the activation period based on the activation signal indicating an FCR-Up Regulation event.

Example B12. The method of any of Examples B3-B11, wherein the synchronization signal, including the AS profile, is received by the RBS 16 prior to the active hour, the method further comprising:
executing the AS profile within the active hour, the AS profile optionally including a profile control, the profile control indicating at least one of:
   synchronization of the RBS 16 in response to every demand from the network management unit 34 to execute the AS profile; and
   local execution on at least one local controller; and
executing at least one power modification process based on at least one threshold indicated by the AS profile.

Example C1. A network management unit 34 (e.g., management node 24) configured to communicate with a power grid operator and with a plurality of RBSs 16, each of the plurality of RBSs 16 being supplied with power from the power grid, the network management unit 34 is configured to:
cause transmission of a synchronization signal to a first RBS 16 of the plurality of RBSs 16, the synchronization signal indicating a schedule including an activation period; and
during the activation period, cause transmission of an activation signal to the first RBS 16, the activation signal being configured to cause the first RBS 16 to modify its power consumption based on the synchronization signal.

Example C2. The network management unit 34 of Example C1 wherein the network management unit 34 is further configured to:
receive an indication from the power grid operator indicating a bidding schedule and a Frequency Containment Reserve, FCR, configuration; and
determine, based on the bidding schedule and the FCR configuration, a primary cluster of the plurality of RBSs 16 for participating in FCR service during an active period of the bidding schedule, the primary cluster including the first RBS 16.

Example C3. The network management unit 34 of Example C2, wherein the synchronization signal indicates an ancillary services, AS, profile, for controlling power consumption of the first RBS 16.

Example C4. The network management unit 34 of Example C3, wherein the AS profile is shared by the RBSs 16 of the primary cluster.

Example C5. The network management unit 34 of Example C4, the network management unit 34 being further configured to:
determine, based on the bidding schedule and the FCR configuration, a standby cluster of the plurality of RBSs 16 different from the primary cluster, the standby cluster including a second RBS 16;
receive a status report from the first RBS 16 indicating a fault in the first RBS 16; and
based on the received status report, substitute the first RBS 16 with the second RBS 16 by:
   causing transmission of a deactivation indication to the first RBS 16 configured to cause the first RBS 16 to ignore future activation signals; and
   causing transmission of the AS profile to the second RBS 16 indicating a reassignment of the second RBS 16 from the standby cluster to the primary cluster.

Example C6. The network management unit 34 of any of Examples C1-C4, wherein the determining of the standby cluster of the plurality of RBSs 16 is based on a proximity of the RBSs 16 of the standby cluster to at least one RBS 16 of the primary cluster.

Example C7. The network management unit 34 of any of Examples C1-C5, wherein the activation signal indicates an FCR-Down Regulation event, the modifying of the power consumption by the first RBS 16 including reducing the power supplied from the power grid to the first RBS 16.

Example C8. The network management unit 34 of Example C7, wherein the first RBS 16 includes a battery 59, the reducing of the power supplied from the power grid including switching from the power supplied by the power grid to power supplied by the battery 59.

Example C9. The network management unit 34 of Example C8, wherein the synchronization signal indicates a first threshold and a second threshold lower than the first threshold, the schedule including a first period prior to the activation period, the synchronization signal being configured to cause the first RBS 16 to:
maintain the battery charge above the first threshold during the first period; and
decrease the battery charge to the second threshold during the activation period based on the activation signal indicating an FCR-Down Regulation event.

Example C10. The network management unit 34 of any of Examples C1-C9, wherein the activation signal indicates an FCR-Up Regulation event, the modifying of the power consumption by the first RBS 16 including increasing the power supplied by the power grid to the first RBS 16.

Example C11. The network management unit 34 of any Example C10, wherein the RBS 16 includes a battery 59, the increasing of the power supplied from the power grid including charging the battery 59.

Example C12. The network management unit 34 of Example C11, wherein the synchronization signal indicates a first threshold and a second threshold higher than the first threshold, the schedule including a first period prior to the activation period, the synchronization signal causing the first RBS 16 to:
maintain the battery charge below the first threshold during the first period; and
increase the battery charge to the second threshold during the activation period based on the activation signal indicating an FCR-Up Regulation event.

Example C13. The network management unit 34 of any of Examples C1-C12, wherein determining the plurality of RBSs 16 to assign to the primary cluster is based on an optimization model, the optimization model being configured to at least one of: maximize profit;
minimize disruption to quality of service;
minimize degradation of the battery; and
minimize penalties from the power grid operator.

Example C14. The network management unit 34 of any of Examples C3-C13, wherein the transmission of the synchronization signal, including the AS profile, to the RBSs16 of each cluster occurs prior to the active hour, the AS profile optionally including a profile control, the profile control indicating at least one of:

Synchronization of the RBS 16 in response to every demand from the network management unit 34 to execute the AS profile, and
local execution on at least one local controller for executing at least one power modification process based on at least one threshold indicated by the AS profile.

Example D1. A method implemented in a network management unit 34 (e.g., management node 24) configured to communicate with a power grid operator and with a plurality of RBSs 16, each of the plurality of RBSs 16 being supplied with power from the power grid, the method comprising:
causing transmission of a synchronization signal to a first RBS 16 of the plurality of RBSs 16, the synchronization signal indicating a schedule including an activation period; and
during the activation period, causing transmission of an activation signal to the first RBS 16, the activation signal being configured to cause the first RBS 16 to modify its power consumption based on the synchronization signal.

Example D2. The method of Example D1 wherein the method is further configured to:
receiving an indication from the power grid operator indicating a bidding schedule and a Frequency Containment Reserve, FCR, configuration; and
determining, based on the bidding schedule and the FCR configuration, a primary cluster of the plurality of RBSs 16 for participating in FCR service during an active period of the bidding schedule, the primary cluster including the first RBS 16.

Example D3. The method of Example D2, wherein the synchronization signal indicates an ancillary services, AS, profile, for controlling power consumption of the first RBS 16.

Example D4. The method of Example D3, wherein the AS profile is shared by the RBSs 16 of the primary cluster.

Example D5. The method of Example D4, the method further comprising:
determining, based on the bidding schedule and the FCR configuration, a standby cluster of the plurality of RBSs different from the primary cluster, the standby cluster including a second RBS 16;
receiving a status report from the first RBS 16 indicating a fault in the first RBS 16; and
based on the received status report, substituting the first RBS 16 with the second RBS 16 by:
   causing transmission of a deactivation indication to the first RBS 16 configured to cause the first RBS 16 to ignore future activation signals; and
   causing transmission of the AS profile to the second RBS 16 indicating a reassignment of the second RBS 16 from the standby cluster to the primary cluster.

Example D6. The method of any of Examples D1-D4, wherein the determining of the standby cluster of the plurality of RBSs 16 is based on a proximity of the RBSs 16 of the standby cluster to at least one RBS 16 of the primary cluster.

Example D7. The method of any of Examples D1-D5, wherein the activation signal indicates an FCR-Down Regulation event, the modifying of the power consumption by the first RBS 16 including reducing the power supplied from the power grid to the first RBS 16.

Example D8. The method of Example D7, wherein the first RBS 16 includes a battery, the reducing of the power supplied from the power grid including switching from the power supplied by the power grid to power supplied by the battery 59.

Example D9. The method of Example D8, wherein the synchronization signal indicates a first threshold and a second threshold lower than the first threshold, the schedule including a first period prior to the activation period, the synchronization signal being configured to cause the first RBS 16 to:
maintain the battery charge above the first threshold during the first period; and
decrease the battery charge to the second threshold during the activation period based on the activation signal indicating an FCR-Down Regulation event.

Example D10. The method of any of Examples D1-D9, wherein the activation signal indicates an FCR-Up Regulation event, the modifying of the power consumption by the first RBS 16 including increasing the power supplied by the power grid to the first RBS 16.

Example D11. The method of any Example D10, wherein the RBS 16 includes a battery 59, the increasing of the power supplied from the power grid including charging the battery 59.

Example D12. The method of Example D11, wherein the synchronization signal indicates a first threshold and a second threshold higher than the first threshold, the schedule including a first period prior to the activation period, the synchronization signal causing the first RBS 16 to:
maintain the battery charge below the first threshold during the first period; and
increase the battery charge to the second threshold during the activation period based on the activation signal indicating an FCR-Up Regulation event.

Example D13. The method of any of Examples D1-D11, wherein determining the plurality of RBSs 16 to assign to the primary cluster is based on an optimization model, the optimization model being configured to at least one of:
maximize profit;
minimize disruption to quality of service;
minimize degradation of the battery; and
minimize penalties from the power grid operator.

Example D14. The method of any of Examples D3-D13, wherein the transmission of the synchronization signal, including the AS profile, to the RBSs 16 of each cluster occurs prior to the active hour, the AS profile optionally including a profile control, the profile control indicating at least one of:
synchronization of the RBS 16 in response to every demand from the network management unit 34 to execute the AS profile, and
local execution on at least one local controller for executing at least one power modification process based on at least one threshold indicated by the AS profile.

Example E1. A system 10 comprising:
a RBS 16 of any one of Examples A1-A12 that is in communication with a network management unit 34 of any one of Examples C1-C13.

| Abbreviation | Explanation |
|---|---|
| AC | Alternating Current |
| AC/DC | Alternating Current Direct Current |
| AS | Ancillary Service |
| BS | Base Station |
| BSS | Battery Storage System |
| BESS | Battery Energy Storage System |
| CSP | Communications Service Providers |
| DOD | Depth of Discharge |
| DSO | Distribution System Operator |
| ENM | Ericsson Network Manager |
| EOL | Battery End of Life |
| FCR-N | Frequency Containment Reserve - Normal |
| FCR-D | Frequency Containment Reserve - Disturbance |
| HZ | Hertz |
| KV | Kilo Volt |
| LP | Linear Programming |
| MILP | Mixed Integer Linear Optimization |
| MNO | Mobile Network Operator |
| MW | Mega Watt |
| OSS | Operating and Support System |
| PP | Pricing Problem |
| PSU | Power Supply Unit |
| QOS | Quality of Service |
| RAN | Radio Access Network |
| RBS | Radio Base Station |
| SBA | Service Base Architecture |
| SOC | State of Charge |
| UPS | Uninterrupted Power Supply |
| VAC | Volt AC |
| TCO | Total Cost of Ownership |
| TSO | Transmission System Operator |
| WP | White Paper |
| 4G | Fourth Generation |
| 5G | Fifth Generation |

Note that although the term “bidding hour” is used herein, any period of time (e.g., 30 minutes, 10 seconds, 3 weeks, etc.) used in a bidding process may be applicable to embodiments of the present disclosure. For example, a particular utility may solicit bids in 10 minute increments/periods, rather than hour increments/periods, and thus “bidding hour” in that instance would refer to one such 10 minute period.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A management node configured to communicate with a power grid operator and with a plurality of radio base stations, RBSs, each of the plurality of RBSs configured to be switchable between power from a power grid and power from a respective plurality of backup battery units associated with the RBS, the management node is configured to:
determine a primary subset of the plurality of RBSs to participate in at least one Frequency Containment Reserve, FCR, event occurring over a predefined time interval;
determine a standby subset of the plurality of RBSs that are each configured to participate in the at least one FCR event in place of a failure of a respective one of the primary subset of the plurality of RBSs;
cause transmission of synchronization signals with operational settings to the primary and standby subsets of the plurality of RBSs, the operational settings being associated with participating in the at least one FCR event; and
during an activation period, cause transmission of an activation signal to at least one of the primary subset of the plurality of RBSs, the activation signal being configured to cause a RBS to modify its power consumption based on the synchronization signal to participate in the at least one FCR event.

2. The management node of claim 1, wherein the determining of the primary and standby subsets of the plurality of RBSs is based on an optimization model that maximizes availability for participating in at least one FCR event and energy compensation event while minimizing:
a penalty cost for failing to meet energy requirements for at least one FCR event;
battery degradation cost;
a physical range of the primary and standby subsets of the plurality of RBSs; and
a number of RBSs in the primary and standby subsets of the plurality of RBSs.

3. The management node of claim 2, wherein the optimization model iteratively generates a set of operational settings according to an iterative pricing problem model, the iterative pricing problem model is configured to compute a contribution of FCR-UP event, FCR-DOWN event and estimated battery degradation for participating in the at least one FCR event for a respective RBS at time t where different FCR events for a RBS are considered;
the FCR-DOWN event corresponding to a reduction in power supplied from the power grid to at least one of the primary subset of the plurality of RBSs; and
the FCR-UP event corresponding to an increase in power supplied by the power grid to at least one of the primary subset of the plurality of RBSs.

4. The management node of claim 3, wherein the iterative pricing problem model output is a RBS configuration among a plurality of RBS configurations having a least cost to participate in the at least one FCR event compared to the cost associated with the remaining RBS configurations, the least cost is based on:
availability to participate in at least one FCR event;
compensation for participating in at least one FCR event;
penalty cost for failing to meet energy requirements for at least one FCR event;
battery degradation cost;
physical range of the primary and standby subsets of the plurality of RBSs;
number of RBSs in the primary and standby subsets of the plurality of RBSs.

5. The management node of claim 2, wherein the battery degradation cost is estimated based on:
linearizing a battery degradation curve that maps a maximum number of battery cycles to a depth of discharge of the battery;
segmenting the linearized battery degradation curve; and
determining a degradation rate for each segment of the linearized battery degradation curve for each event in a battery degradation model.

6. The management node of claim 1, wherein the at least one FCR event corresponds to a plurality of FCR events occurring over the predefined time interval;
a first portion of the primary subset of the plurality of RBSs being scheduled to participate in a first FCR event of the plurality of FCR events; and
a second portion of the primary subset of the plurality of RBSs being scheduled to participate in a second FCR event of the plurality of FCR events, the first portion of the primary subset of the plurality of RBSs being different from the second portion.

7. A radio base station, RBS, in communication with a management node, the RBS configured to be switchable between power from a power grid and power from a plurality of backup battery units associated with the RBS, the radio stations comprising:
processing circuitry configured to:
receive a synchronization signal with operational settings associated with primary and standby subsets of a plurality of RBSs forming a cluster, the operational settings being associated with participating in at least one Frequency Containment Reserve, FCR, event; and
during an activation period, receive an activation signal that is configured to cause the RBS to modify its power consumption based on the synchronization signal in response to the activation signal; and
modify the power consumption of the RBS based on the synchronization signal and the activation signal to participate in the at least one FCR event.

8. The RBS of claim 7, wherein the RBS is part of one of the primary subset and standby subsets of the plurality of RBSs.

9. The RBS of claim 7, wherein the activation signal indicates an FCR-Down event for the RBS to participate in, the modifying of the power consumption by the RBS including reducing the power used from the power grid by the RBS.

10. The RBS of claim 7, wherein the activation signal indicates an FCR-Up event for the RBS to participate in, the modifying of the power consumption by the RBS including increasing the power used from the power grid by the RBS by, at least in part, charging at least one of the plurality of backup battery units.

11. The RBS of claim 7, wherein the synchronization signal is received by the RBS prior to an active time period, the processing circuitry being further configured to:
execute the operational settings within the active time period, the operational settings including a profile control, the profile control indicating at least one of:
synchronization of the RBS in response to every demand from the management node to execute the operational settings; and
local execution on at least one local controller; and
execute at least one power modification process based on at least one threshold indicated by the operational settings.

12. A method implemented by a management node that is configured to communicate with a power grid operator and with a plurality of radio base stations, RBSs, each of the plurality of RBSs configured to be switchable between power from a power grid and power from a respective plurality of backup battery units associated with the RBS, the method comprising:
determining a primary subset of the plurality of RBSs to participate in at least one Frequency Containment Reserve, FCR, event occurring over a predefined time interval;
determining a standby subset of the plurality of RBSs that are each configured to participate in the at least one FCR event in place of a failure of a respective one of the primary subset of the plurality of RBSs;
causing transmission of synchronization signals with operational settings to the primary and standby subsets of the plurality of RBSs, the operational settings being associated with participating in the at least one FCR event; and
during an activation period, causing transmission of an activation signal to at least one of the primary subset of the plurality of RBSs, the activation signal being configured to cause a RBS to modify its power consumption based on the synchronization signal to participate in the at least one FCR event.

13. The method of claim 12, wherein the determining of the primary and standby subsets of the plurality of RBSs is based on an optimization model that maximizes availability for participating in at least one FCR event and energy compensation event while minimizing:
a penalty cost for failing to meet energy requirements for at least one FCR event;
battery degradation cost;
a physical range of the primary and standby subsets of the plurality of RBSs; and
a number of RBSs in the primary and standby subsets of the plurality of RBSs.

14. The method of claim 13, wherein the optimization model iteratively generates a set of operational settings according to an iterative pricing problem model, the iterative pricing problem model is configured to compute a contribution of FCR-UP event, FCR-DOWN event and estimated battery degradation for participating in the at least one FCR event for a respective RBS at time t where different FCR events for a RBS are considered; and
the FCR-DOWN event corresponding to a reduction in power supplied from the power grid to at least one of the primary subset of the plurality of RBSs; and
the FCR-UP event corresponding to an increase in power supplied by the power grid to at least one of the primary subset of the plurality of RBSs.

15. The method of claim 14, wherein the iterative pricing problem model output is a RBS configuration among a plurality of RBS configurations having a least cost to participate in the at least one FCR event compared to the cost associated with the remaining RBS configurations, the least cost is based on:
availability to participate in at least one FCR event;
compensation for participating in at least one FCR event;
penalty cost for failing to meet energy requirements for at least one FCR event;
battery degradation cost;
physical range of the primary and standby subsets of the plurality of RBSs; and
number of RBSs in the primary and standby subsets of the plurality of RBSs.

16. The method of claim 13, wherein the battery degradation cost is estimated based on:
linearizing a battery degradation curve that maps a maximum number of battery cycles to a depth of discharge of the battery;
segmenting the linearized battery degradation curve; and
determining a degradation rate for each segment of the linearized battery degradation curve for each event in a battery degradation model.

17. The method of claim 12, wherein the at least one FCR event corresponds to a plurality of FCR events occurring over the predefined time interval;
a first portion of the primary subset of the plurality of RBSs being scheduled to participate in a first FCR event of the plurality of FCR events; and
a second portion of the primary subset of the plurality of RBSs being scheduled to participate in a second FCR event of the plurality of FCR events, the first portion of the primary subset of the plurality of RBSs being different from the second portion.

18. A method implemented by a radio base station, RBS, that is in communication with a management node, the RBS configured to be switchable between power from a power grid and power from a plurality of backup battery units associated with the RBS, the method comprising:
receiving a synchronization signal with operational settings associated with primary and standby subsets of a plurality of RBSs forming a cluster, the operational settings being associated with participating in at least one Frequency Containment Reserve, FCR, event;
during an activation period, receiving an activation signal that is configured to cause the RBS to modify its power consumption based on the synchronization signal in response to the activation signal; and
modifying the power consumption of the RBS based on the synchronization signal and the activation signal to participate in the at least one FCR event.

19. The method of claim 18, wherein the RBS is part of one of the primary subset and standby subsets of the plurality of RBSs.

20. The method of claim 18, wherein the activation signal indicates an FCR-Down event for the RBS to participate in, the modifying of the power consumption by the RBS including reducing the power used from the power grid by the RBS by, at least in part, charging at least one of the plurality of backup battery units.

21. The method of claim 18, wherein the activation signal indicates an FCR-Up event for the RBS to participate in, the modifying of the power consumption by the RBS including increasing the power used from the power grid by the RBS.

22. The method of claim 18, wherein the synchronization signal is received by the RBS prior to an active time period; and
the method further comprising:
executing the operational settings within the active time period, the operational settings including a profile control, the profile control indicating at least one of:
synchronization of the RBS in response to every demand from the management node to execute the operational settings; and
local execution on at least one local controller; and
executing at least one power modification process based on at least one threshold indicated by the operational settings.
